(19) United States
(12) Patent Application Publication
(10) Pub. No.: US 2025/0013171 A1
(43) Pub. Date: Jan. 9, 2025

(54) IMAGE FORMING APPARATUS

(71) Applicant: CANON KABUSHIKI KAISHA, Tokyo (JP)

(72) Inventor: TAKENORI SUEOKA, Ibaraki (JP)

(21) Appl. No.: 18/760,653

(22) Filed: Jul. 1, 2024

(30) Foreign Application Priority Data
Jul. 4, 2023 (JP) 2023-110366

(51) Int. Cl. G03G 15/16; G03G 15/00

(52) U.S. Cl. CPC G03G 15/1605; G03G 15/5037; G03G 15/5058

(57) ABSTRACT

In an image forming apparatus including a transfer member, a control unit, and a feeding unit including a blowing unit which blows air to leading edge portions of recording materials contained in a container, the control unit sets a transfer voltage for the transfer member during image formation based on detection results by a reading unit when a region to which at least one density acquisition image is to be transferred in a recording material on which a chart is formed is passing through a transfer portion, detection results when a predetermined region closer to the leading edge side than the region to which a plurality of density acquisition images is to be transferred in a conveyance direction of the recording material on which a chart is formed is passing through the transfer portion, and information about densities of the plurality of density acquisition images.

### BACKGROUND

### Field of the Disclosure

Aspects of the present disclosure generally relate to an image forming apparatus, such as a copying machine, a printer, or a facsimile apparatus, using an electrophotographic system or electrostatic recording system.

### Description of the Related Art

In image forming apparatuses using, for example, an electrophotographic system, a toner image formed on an image bearing member, such as a photosensitive member or an intermediate transfer member, is transferred to a recording material. The transfer of a toner image from an image bearing member to a recording material is often performed with a transfer voltage being applied to a transfer member, such as a transfer roller, which forms a transfer portion in abutment contact with the image bearing member. The transfer voltage is able to be determined based on a transfer portion shared voltage, which corresponds to the electrical resistance of the transfer portion detected at the time of, for example, a pre-rotation process before image formation, and a recording material shared voltage, which is preliminarily set according to the type of the recording material. This enables setting an appropriate transfer voltage depending on, for example, an environmental variation, a usage history of the transfer member, or the type of the recording material.

However, since there are various types or states of recording materials which are used for image formation, a preliminarily set default recording material shared voltage may cause excess or deficiency in the transfer voltage. Therefore, providing an adjustment mode for adjusting a setting voltage for a transfer voltage depending on a recording material actually used for image formation has previously been proposed.

Japanese Patent Application Laid-Open No. 2013-37185 discusses an image forming apparatus capable of executing an adjustment mode for adjusting a setting voltage for a secondary transfer voltage. In this adjustment mode, a chart formed by a plurality of patches (test images) being transferred to a sheet of recording material with different secondary transfer voltages switched for the respective patches is output. Then, the densities of the respective patches are detected, and an optimum secondary transfer voltage condition is selected according to the result of such detection.

Here, known configurations of a feeding unit which feeds recording materials (feeds sheets) toward the transfer portion include a configuration which separates and feeds recording materials by blowing air to the recording materials, as discussed in Japanese Patent Application Laid-Open No. 2013-107738.

Using the adjustment mode such as that mentioned above enables easily adjusting a setting voltage for a secondary transfer voltage according to the types or states of recording materials.

However, if there is an electrical resistance unevenness within the surface of a recording material, it may be difficult for the above-mentioned conventional method to appropriately adjust a setting voltage for a secondary transfer voltage.

Particularly, in the case of an image forming apparatus using an “air feeding” method which, at the time of feeding recording materials to a transfer portion, blows air to a stack of recording materials to isolate the stack into individual recording materials and feeds the individual recording materials one by one, an electrical resistance unevenness within the surface of a recording material is likely to become large. This is because the moisture amount of a recording material at a portion thereof to which air has been blown decreases and the electrical resistance of the recording material locally increases.

Even if the above-mentioned adjustment mode in the conventional method is executed with respect to recording materials, it may be impossible to appropriately adjust a setting voltage for a secondary transfer voltage in such a way as to give a sufficient transfer voltage to a portion to which air has been blown.

### SUMMARY

Aspects of the present disclosure are generally directed to, in a configuration which blows air to recording materials at the time of feeding the recording materials, enabling appropriately adjusting a setting voltage for a secondary transfer voltage even with respect to a recording material within the surface of which an electrical resistance unevenness has occurred.

According to an aspect of the present disclosure, an image forming apparatus includes an image bearing member configured to bear a toner image thereon, a transfer member configured to transfer a toner image from the image bearing member to a recording material at a transfer portion, an application unit configured to apply a voltage to the transfer member, a sensor configured to detect a current value of a current flowing to the transfer member when a voltage has been applied from the application unit to the transfer member or a voltage value of a voltage which is applied from the application unit to the transfer member, an image reading unit configured to detect an image on a recording material, a container configured to contain recording materials therein, a blowing unit including a blowing port configured to blow air to recording materials contained in the container, a feeding unit configured to feed a recording material contained in the container toward the transfer portion, and a control unit configured to execute a setting mode for transferring a plurality of test images to a recording material with different test voltages applied to the transfer member during non-image formation and setting a transfer voltage to be applied to the transfer member during image formation based on a detection result obtained by the image reading unit detecting the plurality of test images transferred to the recording material, wherein the control unit is configured to set the transfer voltage to be applied during image formation based on a first detection result obtained by the sensor when a voltage is applied to the transfer member while a first region of a recording material on which the plurality of test images is to be formed is passing through the transfer portion, and a voltage-current characteristic, which is acquired based on a second detection result, which is obtained by the sensor when a voltage is applied to the transfer member while a second region of the recording material on which the plurality of test images is to be formed and which is different from the first region in a conveyance direction of the recording material is passing through the transfer portion, and wherein, when the recording material on which the plurality of test images is to be formed is contained in the container portion, the second region is a region more away from the blowing port than the first region.

Further features of various embodiments will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a block diagram illustrating an outline configuration of a control system of the image forming apparatus.

FIG. 3 is a flowchart illustrating an outline of a procedure for secondary transfer voltage control.

FIG. 4 is a graph illustrating an example of a voltage-current characteristic which is acquired by the secondary transfer voltage control.

FIG. 5 is a table showing an example of a recording material shared voltage table.

FIG. 6 is a schematic diagram of a large chart (L chart) which is output in an adjustment mode.

FIG. 7 is a schematic diagram of a small chart (S chart) which is output in the adjustment mode.

FIG. 8 is a flowchart illustrating an outline of a procedure for the adjustment mode.

FIG. 9 is a schematic diagram of a paper type category selection screen.

FIG. 10 is a schematic diagram of a feeding unit selection screen.

FIG. 11 is a schematic diagram of a secondary transfer voltage adjustment screen.

FIGS. 12A and 12B are graphs illustrating transition of a secondary transfer voltage at the time of outputting of a chart.

FIG. 13A is tables showing an example of a relationship between patch numbers in the chart and adjustment values.

FIG. 13B is tables showing an example of a relationship between patch numbers in the chart and adjustment values.

FIG. 13C is tables showing an example of a relationship between patch numbers in the chart and adjustment values.

FIGS. 14A and 14B are graphs illustrating transition of a secondary transfer voltage at the time of outputting of a chart.

FIG. 15 is a graph illustrating an example of a voltage-current characteristic which is acquired at the time of outputting of a chart.

FIG. 16 is a schematic diagram used to explain a method of detecting the position of a trigger patch.

FIGS. 17A, 17B, 17C, and 17D are graphs used to explain a method of selecting recommended adjustment values.

FIG. 18 is a graph used to explain a correction method for an adjustment value.

FIGS. 19A and 19B are a schematic sectional view used to explain an air blowing unit and a schematic diagram of a recording material, respectively.

FIGS. 20A and 20B are graphs illustrating another example of transition of a secondary transfer voltage at the time of outputting of a chart.

FIGS. 21A and 21B are graphs illustrating another example of a voltage-current characteristic which is acquired at the time of outputting of a chart.

FIG. 22 is a graph illustrating another example of transition of a secondary transfer voltage at the time of outputting of a chart.

FIGS. 23A and 23B are graphs used to explain another example of a correction method for an adjustment value.

FIG. 24 is a schematic diagram of a recording material used to explain another example of an air blowing unit.

### DESCRIPTION OF THE EMBODIMENTS

Various exemplary embodiments, features, and aspects of the disclosure will be described in detail below with reference to the drawings.

### <1. Configuration of Image Forming Apparatus>

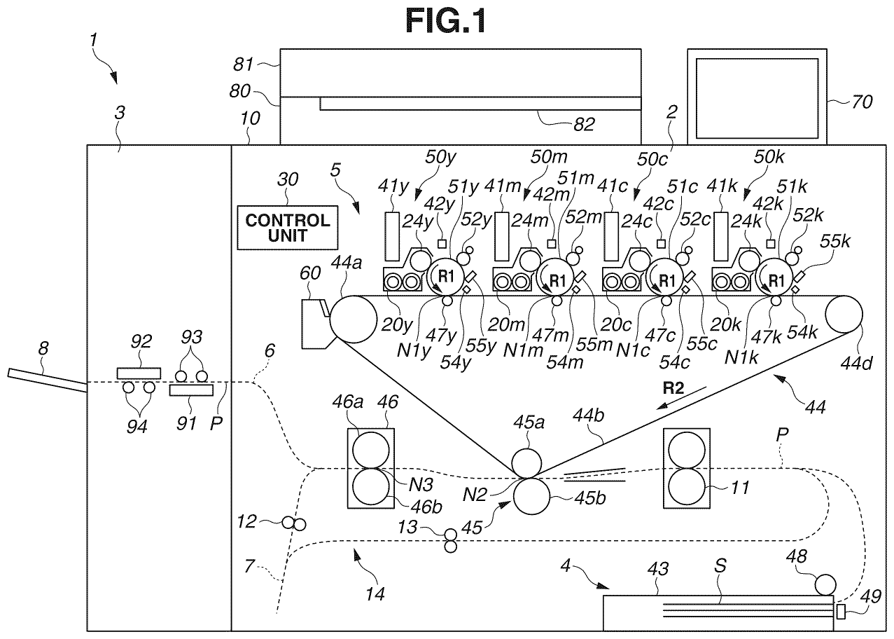

FIG. 1 is a schematic sectional view of an image forming apparatus (image forming system) 1 in a first exemplary embodiment. In the first exemplary embodiment, the image forming apparatus 1 is configured with a printer unit 2, which performs image formation, and a sensing unit 3, which performs reading of a chart for the purpose of adjustment of a secondary transfer voltage, the printer unit 2 and the sensing unit 3 being joined to each other. In the first exemplary embodiment, the printer unit 2 is configured with a tandem-type full-color printer employing an intermediate transfer method, which is capable of forming a full-color image on a recording material S with use of the electrophotographic system. Furthermore, the recording material S may be referred to as “paper”, but, as mentioned below, the recording material S is not limited to paper.

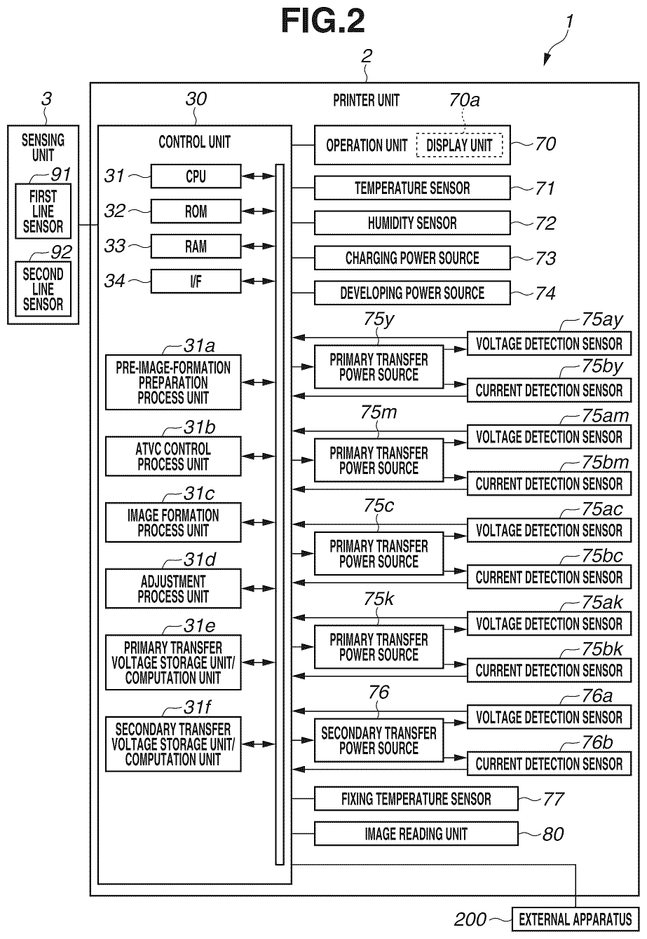

The printer unit 2 includes, for example, a feeding unit (sheet feeding unit) 4, an image forming section 5, a control unit 30, a delivery unit 6 for the sensing unit 3, an operation unit 70, and an image reading unit 80. While, in FIG. 1, only one feeding unit 4 is illustrated, a plurality of feeding units 4 can be included in the printer unit 2. Moreover, the inside of an apparatus body 10 of the image forming apparatus 1 (printer unit 2) is provided with a temperature sensor 71 (FIG. 2), which is capable of detecting the temperature of the inside of the apparatus body 10 (internal temperature), and a humidity sensor 72 (FIG. 2), which is capable of detecting the humidity of the inside of the apparatus body 10 (internal humidity). Each of the temperature sensor 71 and the humidity sensor 72 is an example of an environment detection unit for detecting environmental information which is at least one of the temperature and humidity of at least one of the inside and outside of the image forming apparatus 1. The printer unit 2 is able to form a full-color image with four colors on a recording material (sheet or transfer material) S based image information (image signal) received from the image reading unit 80 or an external apparatus 200 (FIG. 2). Examples of the external apparatus 200 include a host device, such as a personal computer, a digital camera, and a smartphone. Furthermore, the recording material S is a medium on which a toner image is to be formed, and specific examples of the recording material S include, in addition to paper, such as plain paper or heavy paper, a plastic sheet (synthetic paper) as substitute for paper and a sheet for overhead projectors.

The feeding unit 4 includes a cassette 43, serving as a recording material container portion, a feeding member (sheet feeding member) 48, such as a feeding roller or a feeding belt, and an air blowing unit (air isolation device) 49, serving as a recording material isolation unit. The feeding unit 4 causes the air blowing unit 49 to blow air to recording materials S stored in the cassette 43 in a stacking manner to separate the recording materials S, and causes the feeding member 48 to send and feed the uppermost recording material S toward a secondary transfer portion N2 described below. If the stacked recording materials S are electrostatically attracted to each other, double feeding may occur, and, therefore, the feeding unit 4 performs feeding after causing the air blowing unit 49 to blow air to the vicinity of the leading edges of recording materials S with respect to a conveyance direction in which to send a recording material S from the feeding unit 4. In this way, the feeding unit 4 blows air to a stack of recording materials S to separate the stack into individual recording materials S, thus facilitating feeding recording materials S one by one.

The image forming section 5 is able to form an image, based on image information, on a recording material S that is fed from the feeding unit 4 and is moving within a conveyance path (conveyance pathway) P. The image forming section 5 includes, as a plurality of image forming units, first, second, third, and fourth image forming units 50y, 50m, 50c, and 50k for forming yellow (y), magenta (M), cyan (C), and black (Bk) images, respectively. Moreover, the image forming section 5 includes, for example, an intermediate transfer unit 44, a secondary transfer device 45, and a fixing device 46. In some cases, elements having respective identical or corresponding functions or configurations in the image forming units 50y, 50m, 50c, and 50k are described comprehensively while suffixes y, m, c, and k of the reference characters representing which of the elements for colors Y, M, C, and Bk the element concerned is omitted.

The image forming unit 50 includes a photosensitive drum 51, which is a rotatable drum-shaped (cylindrical) photosensitive member (electrophotographic photosensitive member) serving as a first image bearing member. Moreover, the image forming unit 50 includes a charging roller 52, which is a roller-shaped charging member serving as a charging unit. Moreover, the image forming unit 50 includes an exposure device 42 serving as an exposure unit. Moreover, the image forming unit 50 includes a developing device 20 serving as a developing unit. Moreover, the image forming unit 50 includes a primary transfer roller 47, which is a roller-shaped primary transfer member serving as a primary transfer unit (the primary transfer roller 47 is a member constituting the intermediate transfer unit 44 described below). Moreover, the image forming unit 50 includes a pre-exposure device 54 serving as a charge removing unit. Moreover, the image forming unit 50 includes a drum cleaning device 55 serving as a photosensitive member cleaning unit. Moreover, the image forming unit 50 includes a toner bottle 41 serving as a developer resupply container. The image forming unit 50 forms a toner image on an intermediate transfer belt 44b described below.

The photosensitive drum 51 is movable (rotatable) while bearing an electrostatic image (electrostatic latent image) or toner image thereon. In the first exemplary embodiment, the photosensitive drum 51 is a negatively charged organic photoconductor (OPC) with an outer diameter of 30 millimeters (mm). The photosensitive drum 51 includes a cylinder made of aluminum, serving as a base substance, and a surface layer formed on the surface of the cylinder. In the first exemplary embodiment, the surface layer includes three layers, i.e., an undercoat layer, a photo charge generation layer, and a charge transport layer, which are applied and stacked on the base substance in this order. When an image forming operation is started, the photosensitive drum 51 is driven to rotate in the direction of arrow R1 (counterclockwise direction) in FIG. 1 at a predetermined circumferential speed (process speed) by a motor (not illustrated) serving as a driving unit.

The surface of the photosensitive drum 51 rotating is processed to be homogeneously charged to a predetermined potential with a predetermined polarity (in the first exemplary embodiment, negative polarity) by the charging roller 52. In the first exemplary embodiment, the charging roller 52 is a rubber roller which is arranged in contact with the surface of the photosensitive drum 51. The charging roller 52 is driven to rotate along with the rotation of the photosensitive drum 51. To the charging roller 52, a charging power source 73 (FIG. 2) serving as a charging voltage application unit is connected. The charging power source 73 applies a predetermined charging voltage (charging bias) to the charging roller 52 at the time of a charging process.

The surface of the photosensitive drum 51 processed to be electrically charged is scanned and exposed by the exposure device 42 based on image information, so that an electrostatic image is formed on the photosensitive drum 51. In the first exemplary embodiment, the exposure device 42 is a laser scanner. The exposure device 42 emits laser light according to image information about separation colors output from the control unit 30, thus scanning and exposing the surface (outer circumferential surface) of the photosensitive drum 51.

The electrostatic image formed on the photosensitive drum 51 is supplied with toner by the developing device 20 to be developed (made visible), so that a toner image (toner picture image or developer image) is formed on the photosensitive drum 51. In the first exemplary embodiment, the developing device 20 contains, as a developer, a two-component developer including non-magnetic toner particles (toner) and magnetic carrier particles (carriers). The developing device 20 is supplied with toner from the toner bottle 41. The developing device 20 includes a developing sleeve 24 serving as a developer bearing member (developing member). The developing sleeve 24 is made from a non-magnetic material, such as aluminum or non-magnetic stainless steel (in the first exemplary embodiment, aluminum). On the inside of the developing sleeve 24, a magnet roller, which is a roller-shaped magnet, is arranged to be fixed in such a way as not to rotate relative to the body of the developing device 20 (development container). The developing sleeve 24 bears a developer thereon and conveys the developer to a development region, which faces the photosensitive drum 51. To the developing sleeve 24, a developing power source 74 (FIG. 2) serving as a developing voltage application unit is connected. The developing power source 74 applies a predetermined developing voltage (developing bias) to the developing sleeve 24 at the time of a development process. In the first exemplary embodiment, toner electrically charged to the same polarity as the charging polarity of the photosensitive drum 51 (in the first exemplary embodiment, negative polarity) adheres to an exposure portion (image portion) on the photosensitive drum 51 the absolute value of the electric potential of which has decreased due to the photosensitive drum 51 being exposed after being processed to be homogenously charged (reversal developing method). In the first exemplary embodiment, the normal charging polarity of toner, which is the principal charging polarity of toner at the time of development, is the negative polarity.

The intermediate transfer belt 44b, which is an intermediate transfer member configured with an endless belt and which serves as a second image bearing member, is arranged in such a way as to face the four photosensitive drums 51y, 51m, 51c, and 51k. The intermediate transfer belt 44b is suspended in a tensioned manner at a predetermined tension while being wound around a driving roller 44a, a tension roller 44d, and a secondary transfer inner roller 45a, which serve as a plurality of tensile suspension rollers (supporting rollers). The intermediate transfer belt 44b is movable (rotatable) while bearing a toner image thereon. The driving roller 44a is driven to rotate by a motor (not illustrated) serving as a driving unit, thus rotating (revolving) the intermediate transfer belt 44b. The tension roller 44d is used to control the tension of the intermediate transfer belt 44b to a constant value. The tension roller 44d is given a force which pushes out the intermediate transfer belt 44b from the inner circumferential surface side thereof toward the outer circumferential surface side thereof, by an urging force of a spring (not illustrated) serving as an urging unit. This force causes tension of about 2 kilogram-force (kgf) to 5 kgf to be applied to the intermediate transfer belt 44b in the circumferential direction (movement direction of the surface or process progress direction). The secondary transfer inner roller 45a is a thing constituting the secondary transfer device 45 as described below. The intermediate transfer belt 44b receives a drive force transmitted from the driving roller 44a and thus rotates (revolves) at a predetermined circumferential speed (process speed) corresponding to the circumferential speed of the photosensitive drum 51 in the direction of arrow R2 in FIG. 1 (clockwise). On the inner circumferential surface side of the intermediate transfer belt 44b, primary transfer rollers 47y, 47m, 47c, and 47k are arranged in association with the four photosensitive drum 51y, 51m, 51c, and 51k, respectively. In the first exemplary embodiment, the primary transfer roller 47 is arranged at a position opposite to the photosensitive drum 51 across the intermediate transfer belt 44b, and sandwiches the intermediate transfer belt 44b between the primary transfer roller 47 and the photosensitive drum 51. This causes the primary transfer roller 47 to be in abutment contact with the photosensitive drum 51 via the intermediate transfer belt 44b, thus forming a primary transfer portion (primary transfer nip portion) N1 in which the photosensitive drum 51 and the intermediate transfer belt 44b are in contact with each other. The tensile suspension rollers other than the driving roller 44a and the primary transfer rollers 47y, 47m, 47c, and 47k are driven to rotate along with the rotation of the intermediate transfer belt 44b. Moreover, on the outer circumferential surface side of the intermediate transfer belt 44b, a belt cleaning device 60 serving as an intermediate transfer member cleaning unit is arranged at a position opposite to the driving roller 44a across the intermediate transfer belt 44b. The intermediate transfer unit 44 is configured with, for example, the intermediate transfer belt 44b, the tensile suspension rollers 44a, 44d, and 45a, the primary transfer rollers 47y, 47m, 47c, and 47k, and the belt cleaning device 60.

At the primary transfer portion N1, the toner image formed on the photosensitive drum 51 is primarily transferred onto the intermediate transfer belt 44b rotating by the action of the primary transfer roller 47. To the primary transfer roller 47, a primary transfer power source 75 (FIG. 2) serving as a primary transfer voltage application unit is connected. At the time of a primary transfer process, the primary transfer power source 75 applies, to the primary transfer roller 47, a predetermined primary transfer voltage (primary transfer bias), which is a direct-current voltage with a polarity opposite to the normal charging polarity of toner (in the first exemplary embodiment, positive polarity). To the primary transfer power source 75, a voltage detection sensor 75a (FIG. 2) serving as a voltage detection unit for detecting an output voltage and a current detection sensor 75b (FIG. 2) serving as a current detection unit for detecting an output current are connected. In the first exemplary embodiment, the primary transfer power sources 75y, 75m, 75c, and 75k are provided in association with the primary transfer rollers 47y, 47m, 47c, and 47k, respectively, and are able to individually control the respective primary transfer voltages to be applied to the primary transfer rollers 47y, 47m, 47c, and 47k. In the first exemplary embodiment, in response to the primary transfer voltage of positive polarity being applied to the primary transfer roller 47, the toner image of negative polarity on the photosensitive drum 51 is primarily transferred onto the intermediate transfer belt 44b. For example, at the time of formation of a full-color image, toner images of the respective colors Y, M, C, and Bk formed on the respective photosensitive drums 51y, 51m, 51c, and 51k are multiply transferred onto the intermediate transfer belt 44b in such a way as to be sequentially superposed on each other.

On the outer circumferential surface side of the intermediate transfer belt 44b, a secondary transfer outer roller 45b, which is a roller-shaped secondary transfer member, is arranged at a position opposite to the secondary transfer inner roller 45a serving as an opposite member across the intermediate transfer belt 44b. The secondary transfer outer roller 45b constitutes the secondary transfer device 45, serving as a secondary transfer unit, together with the secondary transfer inner roller 45a. The secondary transfer outer roller 45b is in abutting contact with the secondary transfer inner roller 45a via the intermediate transfer belt 44b, thus forming a secondary transfer portion N2 (secondary transfer nip portion) in which the intermediate transfer belt 44b and the secondary transfer outer roller 45b are in contact with each other. At the secondary transfer portion N2, the toner image formed on the intermediate transfer belt 44b is secondarily transferred onto a recording material S which is conveyed while being sandwiched between the intermediate transfer belt 44b and the secondary transfer outer roller 45b (which passes through the secondary transfer portion N2), by the action of the secondary transfer device 45. In the first exemplary embodiment, in response to the secondary transfer voltage of positive polarity being applied to the secondary transfer outer roller 45b, the toner image of negative polarity on the intermediate transfer belt 44b is secondarily transferred onto the recording material S. The recording material S is fed from the feeding unit 4 in parallel with the above-mentioned forming operation for a toner image, and is conveyed to the secondary transfer portion N2 in synchronized timing with the toner image on the intermediate transfer belt 44b by a registration roller 11 serving as a conveyance member provided in the conveyance path P.

In this way, the secondary transfer device 45 is configured to include the secondary transfer inner roller 45a, which serves as an opposite member, and the secondary transfer outer roller 45b, which serves as a secondary transfer member. To the secondary transfer outer roller 45b, a secondary transfer power source 76 (FIG. 2) serving as a secondary transfer voltage application unit is connected. At the time of a secondary transfer process, the secondary transfer power source 76 applies, to the secondary transfer outer roller 45b, a predetermined secondary transfer voltage, which is a direct-current voltage with a polarity opposite to the normal charging polarity of toner (in the first exemplary embodiment, positive polarity). To the secondary transfer power source 76, a voltage detection sensor 76a (FIG. 2) serving as a voltage detection unit for detecting an output voltage and a current detection sensor 76b (FIG. 2) serving as a current detection unit for detecting an output current are connected. In the first exemplary embodiment, a core metal of the secondary transfer inner roller 45a is connected to the ground potential. Then, when the recording material S has been supplied to the secondary transfer portion N2, a secondary transfer voltage controlled to be a constant voltage with a polarity opposite to the normal charging polarity of toner is applied to the secondary transfer outer roller 45b. In the first exemplary embodiment, for example, a secondary transfer voltage of 1 kilovolt (kV) to 6.5 kV is applied and a current of about 15 microamperes (μA) to 100 μA flows, so that the toner image on the intermediate transfer belt 44b is secondarily transferred onto the recording material S. Furthermore, in the first exemplary embodiment, the secondary transfer inner roller 45a is connected to the ground potential, and a voltage is applied from the secondary transfer power source 76 to the secondary transfer outer roller 45b. On the other hand, a voltage can be applied from the secondary transfer power source 76 to the secondary transfer inner roller 45a serving as a secondary transfer member, and the secondary transfer outer roller 45b serving as an opposite member can be connected to the ground potential. In this case, a direct-current voltage with a polarity identical to the normal charging polarity of toner is applied to the secondary transfer inner roller 45a.

The recording material S with the toner image transferred thereto is conveyed to the fixing device 46 serving as a fixing unit. The fixing device 46 includes a fixing roller 46a and a pressure roller 46b. The fixing roller 46a has a heater serving as a heating unit built therein. The pressure roller 46b is pushed toward the fixing roller 46a, thus forming a fixing portion (fixing nip portion) N3, in which the fixing roller 46a and the pressure roller 46b are in contact with each other. The recording material S bearing the unfixed toner image thereon is conveyed while being sandwiched between the fixing roller 46a and the pressure roller 46b in the fixing portion N3 and is thus heated and pressed. This causes the toner image to be fixed (fused or firmly fixed) onto the recording material S. Furthermore, the temperature (fixing temperature) of the fixing roller 46a is detected by a fixing temperature sensor 77 (FIG. 2) and is controlled by the control unit 30.

In the case of one-sided printing, in which an image is formed on one surface of the recording material S, a recording material S with a toner image fixed to one surface thereof in the above-described way is directly delivered from the delivery unit 6 to the sensing unit 3. On the other hand, in the case of two-sided printing, in which images are formed on both surfaces of the recording material S, a recording material S with a toner image fixed to the first surface thereof in the above-described way is conveyed to a reversing conveyance path 7 by, for example, a reversing conveyance roller 12 serving as a reversing conveyance member. After being moved backward in the reversing conveyance path 7, the recording material S with a toner image fixed to the first surface thereof is reversed in conveyance direction and is made upside down, and is then supplied to the secondary transfer portion N2 again by, for example, a two-sided conveyance roller 13 serving as a two-sided conveyance member.

When the recording material S has been supplied to the secondary transfer portion N2 again in the above-described way, a toner image is transferred to the second surface and is fixed thereto, the recording material S is delivered from the delivery unit 6 to the sensing unit 3. In this way, the printer unit 2 in the first exemplary embodiment is able to perform two-sided printing (automatic two-sided printing or duplex printing), in which images are formed on both surfaces of one recording material S. A two-sided mechanism 14 is configured with, for example, the reversing conveyance path 7, the reversing conveyance roller 12, and the two-sided conveyance roller 13. The recording material S with an image or images formed thereon passes through the inside of the sensing unit 3 and is then discharged (output) to a discharge portion 8 provided at the exterior portion of the sensing unit 3 (image forming apparatus 1). Furthermore, in a case where, in an adjustment mode described below, a chart formed with patches being transferred to a recording material S is output, reading of the patches on the chart is performed when the recording material S passes through the inside of the sensing unit 3, and, then, the recording material S is discharged to the discharge portion 8.

With regard to the photosensitive drum 51 after being subjected to primary transfer, electric charge is removed from the surface thereof by the pre-exposure device 54. Moreover, toner remaining on the photosensitive drum 51 without being transferred to the intermediate transfer belt 44b at the time of a primary transfer process (primary transfer residual toner) is removed from the surface of the photosensitive drum 51 by the drum cleaning device 55 and is recovered. The drum cleaning device 55 includes a cleaning blade serving as a cleaning member. The cleaning blade is a plate-like member, which is brought into abutting contact with the photosensitive drum 51 at a predetermined pressing force. The cleaning blade is in abutting contact with the surface of the photosensitive drum 51 in a counter direction relative to the rotational direction of the photosensitive drum 51 in such a manner that the leading edge on the free end portion side of the counter blade points to the upstream side in the rotational direction of the photosensitive drum 51. Moreover, attached substances, such as toner remaining on the intermediate transfer belt 44b without being transferred to the recording material S at the time of a secondary transfer process and paper dust, are removed from the surface of the intermediate transfer belt 44b by the belt cleaning device 60 and are recovered. In the first exemplary embodiment, the belt cleaning device 60 is configured to include a cleaning blade as with the drum cleaning device 55. The recovered substances such as toner recovered by the drum cleaning device 55 and the belt cleaning device 60 are conveyed to a recovery container (not illustrated) and are stored therein.

Furthermore, the printer unit 2 is also able to form a single-color or multi-color image such as a black single-color image using image forming units 50 for desired single color or some of four colors.

Here, in the first exemplary embodiment, the primary transfer roller 47 includes an elastic layer made from ion conductive foamed rubber (nitrile rubber (NBR)) and a core metal. The outer diameter of the primary transfer roller 47 is, for example, 15 mm to 20 mm. Moreover, as the primary transfer roller 47, a roller with an electrical resistance value of 1×10⁵ ohm (Ω) to 1×10⁸Ω (measured at normal temperature and normal humidity (N/N) (23° C. and relative humidity (RH) of 50%), and 2 kV applied) can be favorably used.

Moreover, in the first exemplary embodiment, the intermediate transfer belt 44b is an endless belt having a double-layer structure including a base layer and a surface layer in this order from the inner circumferential surface side. As a material constituting the base layer, a material in which an appropriate amount of carbon black serving as an antistatic agent is contained in, for example, plastic such as polyimide or polycarbonate or any type of rubber can be favorably used. The thickness of the base layer is, for example, 0.05 mm to 0.15 mm. As a material constituting the surface layer, plastic such as fluororesin can be favorably used. The surface layer reduces the attachment force of toner to the surface of the intermediate transfer belt 44b and thus facilitates toner being transferred to a recording material S in the secondary transfer portion N2. The thickness of the surface layer is, for example, 0.0002 mm to 0.020 mm. As a material of the surface layer, for example, one kind of resin material, such as polyurethane, polyester, or epoxy resin or, for example, two or more kinds of materials of elastic materials, such as elastic rubber, elastomer, and butyl rubber, can be used as a base material. Then, with respect to this base material, as a material for reducing surface energy and increasing lubricity, one kind or two or more kinds of powder or particles of, for example, fluororesin or such powder or particles with respective different particle diameters can be dispersed, so that the surface layer can be formed. In the first exemplary embodiment, the intermediate transfer belt 44b has a volume resistivity of 5×10⁸ Ω·cm to 1×10¹⁴ Ω·cm (23° C. and RH of 50%) and a static friction coefficient of 0.15 to 0.6 (23° C., RH of 50%, and TYPE: 94i manufactured by Shinto Scientific Co., Ltd.). Furthermore, in the first exemplary embodiment, the intermediate transfer belt 44b has a double-layer structure, but can be made to have a single-layer structure of, for example, a material equivalent to the above-mentioned base layer.

Moreover, in the first exemplary embodiment, the secondary transfer outer roller 45b includes an elastic layer of ion conductive foamed rubber (NBR) and a core metal. The outer diameter of the secondary transfer outer roller 45b is, for example, 20 mm to 25 mm. Moreover, as the secondary transfer outer roller 45b, a roller with an electrical resistance value of 1×10⁵Ω to 1×10⁸Ω (measured at N/N (23° C. and RH of 50%), and 2 kV applied) can be favorably used.

Moreover, in each image forming unit 50, the photosensitive drum 51 and at least one of the charging roller 52, the developing device 20, and the drum cleaning device 55, which serve as process units acting on the photosensitive drum 51, can be integrally unitized as a process cartridge. Then, the process cartridge can be configured to be attachable to and detachable from the apparatus body 10.

Moreover, on the upper portion of the apparatus body 10, an automatic document conveyance device 81 and an image reading unit 80 are arranged. The automatic document conveyance device 81, which serves as a document conveyance unit, automatically conveys a sheet, such as a recording material S with an image of a document (text or image) formed thereon, to the reading position (which can be configured with at least a part of a platen glass 82 described below) of the image reading unit 80. The image reading unit 80, which serves as a reading unit, is able to read an image on the sheet which has been conveyed to the above-mentioned reading position by the automatic document conveyance device 81. Moreover, the image reading unit 80 is able to read an image on a sheet, such as a recording material S with an image of a document (text or image) formed thereon, which has been placed on the platen glass 82. The image reading unit 80 is configured to cause a light source (not illustrated) to illuminate a sheet and cause an image reading element (not illustrated) to read an image on the sheet at a predetermined dot density. Thus, the image reading unit 80 optically reads an image on the sheet and converts the read image into an electrical signal.

### <2. Control Aspects>

FIG. 2 is a block diagram illustrating an outline configuration of a control system of the image forming apparatus 1 in the first exemplary embodiment. As illustrated in FIG. 2, the control unit 30 is configured with a computer. The control unit 30 includes, for example, a central processing unit (CPU) 31, a read-only memory (ROM) 32 (including a rewritable one), which stores, for example, a program for controlling each unit, a random access memory (RAM) 33, which temporarily stores data, and an input-output circuit (interface (I/F)) 34, which performs inputting and outputting of signals with an external unit. The CPU 31 is a microprocessor which manages the overall control of the image forming apparatus 1, and is the main constituent of a system controller. The CPU 31 is connected to the feeding unit 4, the image forming section 5, the delivery unit 6, the operation unit 70, the sensing unit 3, and the image reading unit 80 via the input-output circuit 34, exchanges signals with these units, and controls the respective operations of these units. The ROM 32 has stored therein, for example, an image forming control sequence for forming an image on a recording material S. For example, to the control unit 30, the charging power source 73, the developing power source 74, the primary transfer power source 75, and the secondary transfer power source 76 are connected, and these are controlled by respective signals output from the control unit 30. Moreover, to the control unit 30, the temperature sensor 71, the humidity sensor 72, the voltage detection sensor 75a and the current detection sensor 75b for the primary transfer power source 75, the voltage detection sensor 76a and the current detection sensor 76b for the secondary transfer power source 76, and the fixing temperature sensor 77 are connected. Signals (pieces of information) indicating detection results obtained by the respective sensors are input to the control unit 30.

The operation unit 70 includes operation buttons (such as a numeric keypad), serving as an input unit, and a display unit 70a configured with, for example, a liquid crystal panel serving as a display unit. Furthermore, in the first exemplary embodiment, the display unit 70a is configured as a touch panel and also has the function of an input unit. The operator, such as a user or a service engineer, is able to operate the operation unit 70 to input an instruction for executing a job (described below) to the control unit 30. Upon receiving control signals output from the operation unit 70, the control unit 30 is able to perform control to cause the respective devices of the image forming apparatus 1 to operate to execute a job. Furthermore, the image forming apparatus 1 is also able to execute a job based on an image forming signal (image data and a control instruction) coming from an external apparatus 200, such as a personal computer.

In the first exemplary embodiment, the control unit 30 includes a pre-image-formation preparation process unit 31a, an active transfer voltage control (ATVC) control process unit 31b, an image formation process unit 31c, and an adjustment process unit 31d. Moreover, the control unit 30 includes a primary transfer voltage storage unit/computation unit 31e and a secondary transfer voltage storage unit/computation unit 31f. Furthermore, these process units and storage units/computation units can be provided as a part of the CPU 31 or the RAM 33. For example, the control unit 30 (in more detail, the image formation process unit 31c) is able to perform control to execute a job as mentioned above. Moreover, the control unit 30 (in more detail, the ATVC control process unit 31b) is able to perform control to perform ATVC control (setting mode) of the primary transfer portion N1 and the secondary transfer portion N2. Details of the ATVC control are described below. Moreover, the control unit 30 (in more detail, the adjustment process unit 31d) is able to perform control to execute an adjustment mode for adjusting a setting voltage for the secondary transfer voltage. Details of the adjustment mode are described below.

Here, the image forming apparatus 1 executes a job (image output operation or print job) which is a series of operations for forming an image or images on a single or a plurality of recording materials S to be output, which is started in response to one start instruction. Generally, the job includes an image formation process, a pre-rotation process, an inter-sheet process, which is performed in a case where images are formed on a plurality of recording materials S, and a post-rotation process. The image formation process is a period in which to perform, with regard to an image to be actually formed on a recording material S to be output, formation of an electrostatic image, formation of a toner image, and primary transfer, secondary transfer, and fixing of the toner image, and the time of image formation (image forming period) refers to this period. In more detail, the timing for the time of image formation differs depending on the positions at which the respective processes for formation of an electrostatic image, formation of a toner image, and primary transfer, secondary transfer, and fixing of the toner image are performed. The pre-rotation process is a period in which to perform a preparatory operation before the image formation process, from the time when the start instruction has been input to the time when an image begins to be actually formed. The inter-sheet process (inter-image process) is a period corresponding to a space between a recording material S and a recording material S in serially performing image formation on a plurality of recording materials S (serial image formation). The post-rotation process is a period in which to perform an organizing operation (preparatory operation) after the image formation process. The time of non-image formation (non-image forming period) refers to a period other than the time of image formation, and includes, for example, the above-mentioned pre-rotation process, inter-sheet process, post-rotation process, and a pre-multi-rotation process, which is a preparatory operation at the time of powering-on of the image forming apparatus 1 or at the time of recovery from a sleep state thereof.

### <3. Configuration of Sensing Unit>

Next, a configuration of the sensing unit 3, which has the function of reading a chart which has been output in an adjustment mode for adjusting a setting voltage for the secondary transfer voltage, is described.

As illustrated in FIG. 1, a conveyance path P through which a recording material S passes is provided inside the sensing unit 3, and a first line sensor 91 and a second line sensor 92 are provided in such a way as to sandwich the conveyance path P from the front and back sides. The first line sensor 91 is arranged in such a way as to face the conveyance path P from below in FIG. 1 on the more upstream side than the second line sensor 92 in the conveyance direction of a recording material S. Moreover, the second line sensor 92 is arranged in such a way as to face the conveyance path P from above in FIG. 1 on the more downstream side than the first line sensor 91 in the conveyance direction of a recording material S. In the first exemplary embodiment, in the case of performing adjustment of a secondary transfer voltage at the time of two-sided printing in the adjustment mode, a recording material S with a chart formed thereon passes through the conveyance path P inside the sensing unit 3 in such a manner that the upper side in FIG. 1 becomes the second surface and the lower side in FIG. 1 becomes the first surface. Thus, since the first line sensor 91 faces the first surface of a recording material S and the second line sensor 92 faces the second surface of the recording material S, images (patches) of the chart formed on both surfaces of the recording material S are able to be read during one passage of the recording material S.

Moreover, a first presser roller 93 is arranged at a position facing the first line sensor 91, and a second presser roller 94 is arranged at a position facing the second line sensor 92. At the time of reading of a chart, the first and second presser rollers 93 and 94 stabilize the attitude of a recording material S, thus stabilizing a result of reading. The recording material S having passed through the sensing unit 3 is discharged to the discharge portion 8.

As each of the first and second line sensors 91 and 92, for example, a contact image sensor (CIS) can be favorably used. In the first exemplary embodiment, each of the first and second line sensors 91 and 92 is able to read a chart at a resolution of about 300 dots per inch (dpi). In the first exemplary embodiment, image data read by each of the first and second line sensors 91 and 92 is handled as brightness values of 0 to 255 in each of red (R), green (G), and blue (B) by the control unit 30.

As illustrated in FIG. 2, the sensing unit 3 is connected to the control unit 30, and is able to deliver information read by the first and second line sensors 91 and 92 (brightness information related to densities) to the control unit 30.

### <4. Control of Secondary Transfer Voltage>

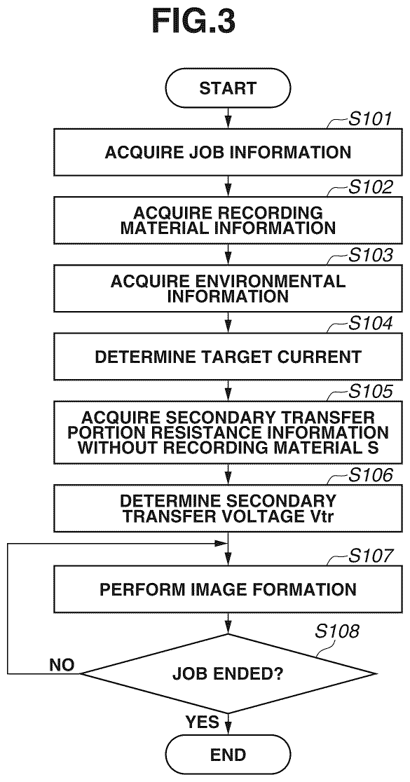

Next, control of a secondary transfer voltage is described. FIG. 3 is a flowchart illustrating the outline of a procedure for control of a secondary transfer voltage in the first exemplary embodiment. While, generally, the control of a secondary transfer voltage includes constant voltage control and constant current control, in the first exemplary embodiment, constant voltage control is used.

First, in step S101, the control unit 30 (pre-image-formation preparation process unit 31a) acquires information about a job from the operation unit 70 or the external apparatus 200 and then starts an operation for the job. The information about a job includes image information designated by the operator and information about a recording material S. The information about a recording material S includes information about the size of the recording material S and information about the type of the recording material S (what is called “paper type category”), such as “thin paper, plain paper, heavy paper, . . . ”.

Furthermore, the type of a recording material S comprehends optional information capable of discriminating a recording material S, such as an attribute that is based on a general characteristic such as plain paper, heavy paper, thin paper, glossy paper, or coated paper (what is called “paper type category”), a brand, a part number, a grammage, and a thickness. In step S102, the control unit 30 (pre-image-formation preparation process unit 31a) writes this information about a job in the RAM 33.

Next, in step S103, the control unit 30 (pre-image-formation preparation process unit 31a) acquires environmental information detected by the temperature sensor 71 and the humidity sensor 72. Moreover, information indicating a correlative relationship between the environmental information and a target current Itarget for transferring a toner image on the intermediate transfer belt 44b onto a recording material S is preliminarily stored in the ROM 32. The control unit 30 (secondary transfer voltage storage unit/computation unit 31f) obtains a target current Itarget corresponding to an environment from the above-mentioned information indicating a relationship between the environmental information and the target current Itarget based on the environmental information read and acquired in step S103. Then, in step S104, the control unit 30 (secondary transfer voltage storage unit/computation unit 31f) writes this target current Itarget in the RAM 33 (or the secondary transfer voltage storage unit/computation unit 31f). Furthermore, the reason of changing the target current Itarget according to the environmental information is that the amount of electric charge of toner varies depending on an environment. The target current Itarget in the first exemplary embodiment is a secondary transfer current value enabling transferring an image with the maximum toner application amount (in the first exemplary embodiment, secondary color whole area solid), which is preliminarily obtained for each environment with use of the image forming apparatus 1.

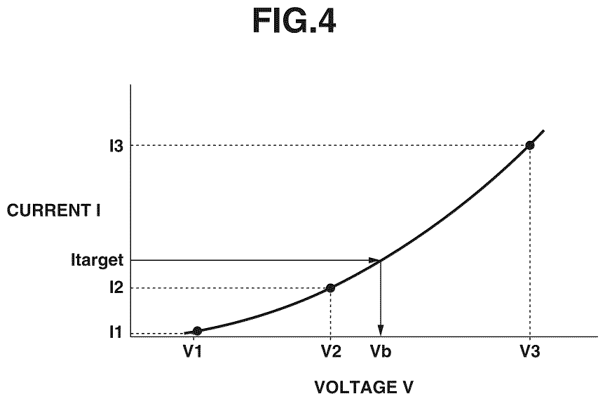

Next, in step S105, before a toner image on the intermediate transfer belt 44b and a recording material S to which the toner image is to be transferred arrive at the secondary transfer portion N2, the control unit 30 (ATVC control process unit 31b) acquires information about an electrical resistance of the secondary transfer portion N2 by active transfer voltage control (ATVC). Thus, the control unit 30 (ATVC control process unit 31b) supplies predetermined voltages with a plurality of levels from the secondary transfer power source 76 to the secondary transfer outer roller 45b in a state in which the secondary transfer outer roller 45b and the intermediate transfer belt 44b are in contact with each other. Then, the control unit 30 (ATVC control process unit 31b) causes the current detection sensor 76b to detect a current value obtained when a predetermined voltage is supplied and thus acquires a relationship between the voltage and the current (voltage-current characteristic) such as that illustrated in FIG. 4. The control unit 30 (ATVC control process unit 31b) writes information about this relationship between the voltage and the current in the RAM 33 (or the secondary transfer voltage storage unit/computation unit 31f). This relationship between the voltage and the current varies according to an electrical resistance of the secondary transfer portion N2. Furthermore, predetermined currents with a plurality of levels can be supplied from the secondary transfer power source 76 to the secondary transfer outer roller 45b and a voltage occurring at that time can be detected by the voltage detection sensor 76a. In the configuration of the first exemplary embodiment, the above-mentioned relationship between the voltage and the current is not a relationship in which the current linearly changes relative to (is proportionate to) the voltage but a relationship in which the current changes in such a way as to be expressed by a polynomial having a degree of 2 or more (in the first exemplary embodiment, a quadratic expression). Therefore, in the first exemplary embodiment, to enable expressing the above-mentioned relationship between the current and the voltage by a polynomial, predetermined voltages or currents which are suppled in acquiring information about an electrical resistance of the secondary transfer portion N2 are set to multiple stages of three or more points.

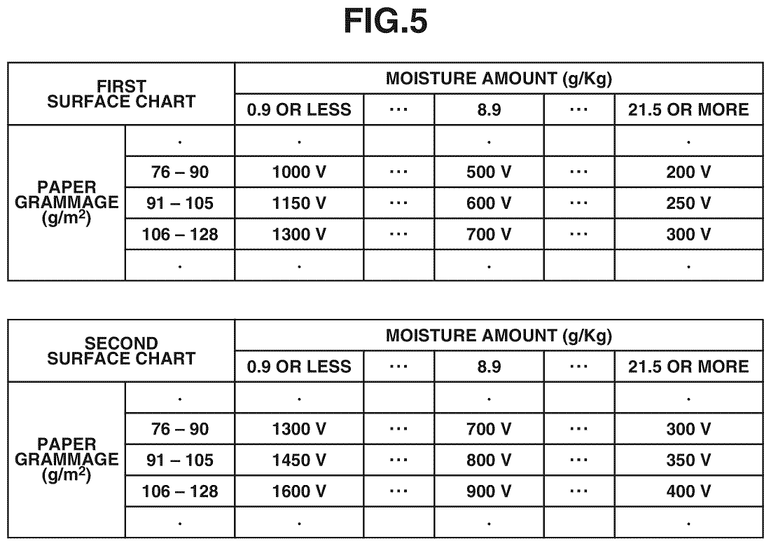

Next, in step S106, the control unit 30 (secondary transfer voltage storage unit/computation unit 31f) obtains a voltage value to be applied from the secondary transfer power source 76 to the secondary transfer outer roller 45b. Thus, the control unit 30 (secondary transfer voltage storage unit/computation unit 31f) obtains a voltage value Vb required for causing the target current Itarget to flow without a recording material S being present in the secondary transfer portion N2, based on the target current Itarget written in the RAM 33 in step S104 and the relationship between the voltage and the current obtained in step S105. The voltage value Vb is equivalent to a secondary transfer portion shared voltage (a transfer voltage allocated for an electrical resistance of the secondary transfer portion N2). Moreover, in the ROM 32, information for obtaining a recording material shared voltage (a transfer voltage allocated for an electrical resistance of the recording material S) Vp, such as that illustrated in FIG. 5, is preliminarily stored. This information is set as table data representing a relationship between an environment moisture amount (absolute moisture amount) and the recording material shared voltage Vp for each classification of the grammage for each paper type category of the recording material S. Moreover, since a recording material S having passed through the fixing device 46 once decreases in the contained moisture amount and, therefore, increases in the electrical resistance, respective different tables are prepared for the first surface and the second surface. The control unit 30 (secondary transfer voltage storage unit/computation unit 31f) obtains the recording material shared voltage Vp from the above-mentioned table data based on the information about a job acquired in step S101 and the environmental information acquired in step S103. Furthermore, the table data for obtaining the recording material shared voltage Vp, such as that illustrated in FIG. 5, is the one preliminarily obtained by, for example, experiment. Moreover, the control unit 30 is able to obtain an environment moisture amount based on temperature information acquired by the temperature sensor 71 and humidity information acquired by the humidity sensor 72. Moreover, in a case where an adjustment value is preliminarily set by an adjustment mode for adjusting a setting value for a secondary transfer voltage described below, the control unit 30 (secondary transfer voltage storage unit/computation unit 31f) obtains an adjustment amount ΔV corresponding to the set adjustment value. The adjustment amount ΔV, in the case of being set by the adjustment mode, is preliminarily stored in the RAM 33 (or the secondary transfer voltage storage unit/computation unit 31f). The control unit 30 (secondary transfer voltage storage unit/computation unit 31f) obtains “Vb+Vp+ΔV”, which is obtained by adding together the above-mentioned secondary transfer portion shared voltage Vb, recording material shared voltage Vp, and adjustment amount ΔV, as a secondary transfer voltage Vtr to be applied from the secondary transfer power source 76 to the secondary transfer outer roller 45b when the recording material S is passing through the secondary transfer portion N2. Then, the control unit 30 writes the obtained secondary transfer voltage Vtr (=Vb+Vp+ΔV) in the RAM 33 (or the secondary transfer voltage storage unit/computation unit 31f).

Here, the recording material shared voltage Vp may also change depending on, besides information related to the electrical resistance of a recording material S (for example, the grammage), the surface property of a recording material S. Therefore, the above-mentioned table data can be set in such a manner that the recording material shared voltage Vp changes even according to information related to the surface property of a recording material S. Moreover, in the first exemplary embodiment, information related to the electrical resistance of a recording material S (additionally, information related to the surface property of a recording material S) is included in the information about a job acquired in step S101. However, the image forming apparatus 1 can be provided with a measurement unit for detecting the thickness of a recording material S or the surface property of a recording material S and the recording material shared voltage Vp can be obtained based on information obtained by the measurement unit.

Next, in step S107, the control unit 30 (image formation process unit 31c) performs control to perform image formation, convey the recording material S to the secondary transfer portion N2, and apply the secondary transfer voltage Vtr determined in the above-described way, thus performing secondary transfer. Then, in step S108, the control unit 30 (image formation process unit 31c) repeats a processing operation in step S107 until transferring all of the images included in the job to recording materials S and completely outputting the recording materials S.

Furthermore, while, with regard to the primary transfer portion N1, ATVC control similar to that described above is also performed during a period from the time when a job is started to the time when a toner image is conveyed to the primary transfer portion N1, the detailed description of such ATVC control is omitted here.

### <5. Outline of Adjustment Mode>

Next, a simple adjustment mode (here, also simply referred to “adjustment mode”) for adjusting a setting voltage for a secondary transfer voltage is described. There is a case where, depending on the types or states of recording materials S which are used for image formation, the contained moisture amount or electrical resistance value of a recording material S is greatly different from that of the standard recording material S. In this case, the setting voltage for a secondary transfer voltage using the default recording material shared voltage Vp preliminarily set in the above-described way may not enable performing appropriate transfer.

First, if the secondary transfer voltage is insufficient, it is not possible to sufficiently transfer a toner image on the intermediate transfer belt 44b to a recording material S, so that the density of an image decreases. For example, a case where the electrical resistance value of a recording material S is higher than a value assumed for each paper type category (corresponding to the recording material shared voltage Vp) or a case where a recording material S has a decreased contained moisture amount (is dried) and an increased electrical resistance value due to a storage condition of the recording material S are conceivable. With respect to such cases, it is desired to increase the setting voltage for a secondary transfer voltage (increase the absolute value thereof) by, for example, increasing the recording material shared voltage Vp.

Conversely, if the secondary transfer voltage is higher than necessary, an image defect may occur due to the occurrence of abnormal electrical discharge or the electric charge of toner may invert in response to electrical discharge in the secondary transfer portion N2, so that the transferability may decrease. For example, a case where the electrical resistance value of a recording material S is lower than a value assumed for each paper type category (corresponding to the recording material shared voltage Vp) or a case where a recording material S has an increased contained moisture amount (has taken up moisture) and a decreased electrical resistance value due to a storage condition of the recording material S are conceivable.

With respect to such cases, it is desired to decrease the setting voltage for a secondary transfer voltage (decrease the absolute value thereof) by, for example, decreasing the recording material shared voltage Vp.

Therefore, it is desired for the operator, such as a user or a service engineer, to adjust (change) the setting voltage for a secondary transfer voltage at the time of execution of a job to an optimum value by, for example, adjusting (changing) the recording material shared voltage Vp depending on a recording material S to be actually used for image formation. In other words, it only needs to be able to select the optimum recording material shared voltage Vp corresponding to a recording material S to be actually used for image formation. It is also conceivable to perform such adjustment by the following method. For example, the conceivable method is a method in which the operator outputs an image for outputting while switching secondary transfer voltages for each recording material S, checks the presence or absence of an image defect occurring in the output image, and determines the optimum setting voltage for a secondary transfer voltage (in more detail, the recording material shared voltage Vp+the adjustment amount ΔV). However, since this method repeats outputting of an image and adjustment of the setting voltage for a secondary transfer voltage, the number of recording materials S which go to waste may increase or a lot of time may be consumed.

Therefore, in the first exemplary embodiment, the image forming apparatus 1 is able to execute an adjustment mode for adjusting a setting voltage for a secondary transfer voltage. In the adjustment mode, a chart formed with a plurality of patches of typical colors (a test image, a test pattern, or a test toner image) being transferred to a recording material S to be actually used for image formation while setting voltages for secondary transfer voltages are switched for the respective patches is output.

Then, based on a result obtained by the output chart being read by the sensing unit 3, an optimum setting voltage for a secondary transfer voltage (in more detail, the recording material shared voltage Vp+the adjustment amount ΔV) is determined. Particularly, in the first exemplary embodiment, based on brightness information (density information) about a solid patch (a patch of a solid image which is an image with the maximum toner application amount) on the chart, an adjustment amount ΔV recommended to optimize the density of the solid image (in more detail, an adjustment value N corresponding to the adjustment amount ΔV) is presented. This enables more appropriately adjusting setting of a secondary transfer voltage while decreasing the necessity of the operator visually checking the presence or absence of an image defect and thus reducing the operation burden on the operator.

### <6. Chart>

Next, a chart (adjustment chart) which is output in the adjustment mode in the first exemplary embodiment is described. In the first exemplary embodiment, different charts are output depending on sizes of recording materials S which are used for outputting of the charts. Furthermore, the length of a recording material S in the conveyance direction of the recording material S is also referred to simply as a “conveyance direction length”, and the length of a recording material S in a direction approximately perpendicular to the conveyance direction of the recording material S is also referred to simply as a “width”. The conveyance direction of a recording material S is approximately parallel to the sub-scanning direction (a movement direction of the surface of the photosensitive drum 51 or the intermediate transfer belt 44b), and the direction approximately perpendicular to the conveyance direction of a recording material S (here, also referred to as a “width direction”) is approximately parallel to the main scanning direction (a direction approximately perpendicular to the movement direction of the surface of the photosensitive drum 51 or the intermediate transfer belt 44b). Furthermore, even with respect to a chart, image data defining the chart, or a patch formed in the chart, the lengths corresponding to the above-mentioned “conveyance direction length” and “width” of a recording material S are also referred to simply as “conveyance direction length” and “width”, respectively.

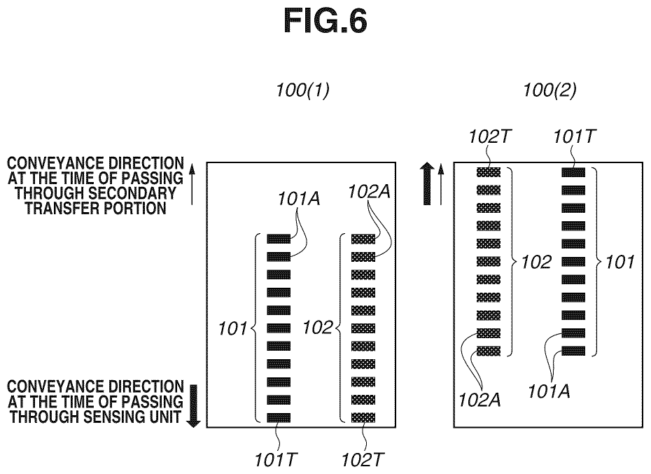

FIG. 6 is a schematic diagram illustrating a large chart (also referred to as an “L chart”) 100, which is a chart formed in a case where the conveyance direction length of a recording material S is greater than or equal to 420 mm (the long side of A3 size) and the width of the recording material S is greater than or equal to 279.4 mm (the long side of LTR size).

Large chart data (also referred to as “L chart data”), which is image data defining the L chart 100 corresponds to the maximum passing paper size. The image size of the L chart data is almost “13 inches (˜ 330 mm) in width×19.2 inches (˜ 487 mm) in conveyance direction length”. An L chart 100 corresponding to image data clipped from the L chart data according to the size of a recording material S is output. At this time, image data is clipped from the L chart data in conformity with the size of a recording material S based on the leading edge in the reading direction and the center in the width direction. FIG. 6 illustrates a case where the size of a recording material S is A3 size (longitudinal feed). For example, in a case where a recording material S that is used for outputting of the L chart 100 is A3 size (longitudinal feed) (297 mm in width×420 mm in conveyance direction length), image data with a size of “292 mm in width×415 mm in conveyance direction length” is clipped from the L chart data. Then, an image corresponding to the clipped image data is formed on a recording material S of A3 size (longitudinal feed) with margins of 2.5 mm left at the respective end portions based on the leading edge in the reading direction and the center in the width direction. Furthermore, such a margin is set to, typically, about 2 mm to 10 mm.

In the L chart 100, a total of 11 sets each including a blue (B) solid patch 101 and a black (Bk) solid patch 102 arranged side by side in the width direction are arranged side by side in the conveyance direction of a recording material S. The L chart 100 illustrated in FIG. 6 includes the first surface chart 100(1) and the second surface chart 100(2). While, after passing through the secondary transfer portion N2, the second surface chart passes through the inside of the sensing unit 3 without turning around, the first surface chart passes through the reversing conveyance path 7 once. Therefore, the first surface chart differs in the orientation thereof between when passing through the secondary transfer portion N2 and when passing through the inside of the sensing unit 3. In FIG. 6, the conveyance direction of the chart when passing through the secondary transfer portion N2 is indicated by a thin arrow, and the conveyance direction of the chart when passing through the inside of the sensing unit 3 is indicated by a thick arrow. In the first exemplary embodiment, the patches at the leading ends of the B solid patches 101 and the Bk solid patches 102 when passing through the inside of the sensing unit 3 are position information detection patches (here, also referred to as “trigger patches”) 101T and 102T, respectively. The trigger patches 101T and 102T are used to accurately detect the positions of patch columns when the B solid patches 101 and the Bk solid patches 102 are read by the first and second line sensors 91 and 92. Of the B solid patches 101 and the Bk solid patches 102, excluding the trigger patches 101T and 102T, two sets of the remaining 10 patches are brightness information (density information) acquisition patches (here, also referred to as “adjustment patches”) 101A and 102A. The adjustment patches 101A and 102A are transferred to a recording material S with respective different secondary transfer voltages Vtr applied.

In the first exemplary embodiment, the size of each of the patches (adjustment patches and trigger patches) is about “15 mm in conveyance direction length×40 mm in width”, and a spacing of 15 mm is provided between the B solid patches 101 and between the Bk solid patches 102 in the conveyance direction of a recording material S. Considering reading at the first and second line sensors 91 and 92, if the size of each patch (particularly, adjustment patch) is too small, the variation of a reading result becomes large under the influence of a formation unevenness (for example, unevenness of rough parts caused by paper fiber) of the recording material S. Therefore, it is desirable that the size of each patch (particularly, adjustment patch) be somewhat large in area, and it is desirable that the area of each patch be 600 mm² or more. However, if the size of each patch (particularly, adjustment patch) is made too large, the number of secondary transfer voltages Vtr able to be allocated within a chart becomes small. In the first exemplary embodiment, in the L chart 100, a patch size which allows about 10 levels of secondary transfer voltages Vtr to be allocated is employed. Moreover, the spacing between patches in the conveyance direction of a recording material S is set in such a way as to enable switching between secondary transfer voltages Vtr, and it is desirable that the spacing between patches be 15 mm or more.

Moreover, in the first exemplary embodiment, on the first surface chart 100(1) and the second surface chart 100(2) of the L chart 100, the B solid patches 101 and the Bk solid patches 102 are arranged not to overlap between the front surface and back surface of the recording material S. The reason for this is to avoid an influence on a detected brightness caused by see-through at the time of reading by the first and second line sensors 91 and 92. This see-through may occur, particularly, in a recording material S with a small grammage.

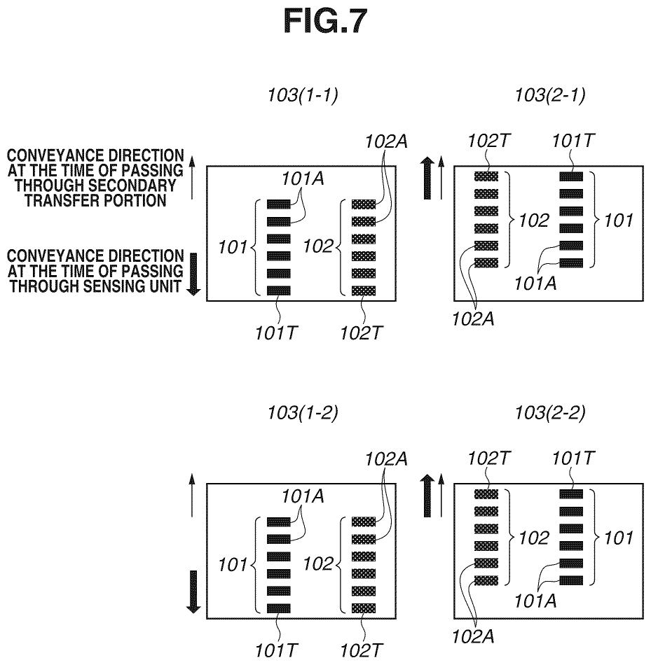

FIG. 7 is a schematic diagram illustrating a small chart (also referred to as an “S chart”) 103, which is a chart formed in a case where the conveyance direction length of a recording material S is greater than or equal to 210 mm (the short side of A4 size) and less than 420 mm (the long side of A3 size) and the width of the recording material S is greater than or equal to 160 mm.

Small chart data (also referred to as “S chart data”), which is image data defining the S chart 103, corresponds to one half of the maximum passing paper size. The image size of the S chart data is almost “13 inches (≈330 mm) in width×9.6 inches (≈243 mm) in conveyance direction length”. In a case where the size of a recording material S is, for example, A4 (lateral feed) or LTR (lateral feed), an S chart 103 corresponding to image data clipped from the S chart data according to the size of a recording material S is output. At this time, image data is clipped from the S chart data in conformity with the size of a recording material S based on the leading edge in the reading direction and the center in the width direction. FIG. 7 illustrates a case where the size of a recording material S is A4 size (lateral feed). For example, in a case where a recording material S that is used for outputting of the S chart 103 is A4 size (lateral feed) (210 mm in conveyance direction length×297 mm in width), image data with a size of “205 mm in conveyance direction length×292 mm in width” is clipped from the S chart data. Then, an image corresponding to the clipped image data is formed on a recording material S of A4 size (lateral feed) with margins of 2.5 mm left at the respective end portions based on the leading edge in the reading direction and the center in the width direction. Furthermore, such a margin is set to, typically, about 2 mm to 10 mm.

In the S chart 103, a total of 12 sets each including a blue (B) solid patch 101 and a black (Bk) solid patch 102 arranged side by side in the width direction are arranged side by side in the conveyance direction of a recording material S over two recording materials S. In the S chart 103, the number of recording materials S which are used for formation of a chart is set to two, so that the number of patches similar to that in the L chart 100 can be secured to enable performing equivalent adjustment. The S chart 103 illustrated in FIG. 7 includes the first surface chart 103(1-1) of the first recording material S, the first surface chart 103(1-2) of the second recording material S, the second surface chart 103(2-1) of the first recording material S, and the second surface chart 103(2-2) of the second recording material S. While, after passing through the secondary transfer portion N2, the second surface chart passes through the inside of the sensing unit 3 without turning around, the first surface chart passes through the reversing conveyance path 7 once. Therefore, the first surface chart differs in the orientation thereof between when passing through the secondary transfer portion N2 and when passing through the inside of the sensing unit 3. In FIG. 7, the conveyance direction of the chart when passing through the secondary transfer portion N2 is indicated by a thin arrow, and the conveyance direction of the chart when passing through the inside of the sensing unit 3 is indicated by a thick arrow. In the first exemplary embodiment, with regard to patches which are formed on one surface of a recording material S, the patches at the leading ends of the B solid patches 101 and the Bk solid patches 102 when passing through the inside of the sensing unit 3 are position information detection trigger patches 101T and 102T, respectively. The trigger patches 101T and 102T are used to accurately detect the positions of patch columns when the B solid patches 101 and the Bk solid patches 102 are read by the first and second line sensors 91 and 92. Of the B solid patches 101 and the Bk solid patches 102, excluding the trigger patches 101T and 102T, two sets of the remaining 10 patches are brightness information (density information) acquisition adjustment patches 101A and 102A. The adjustment patches 101A and 102A are transferred to recording materials S with respective different secondary transfer voltages Vtr applied.

As mentioned above, in the first exemplary embodiment, the size of each of the patches (adjustment patches and trigger patches) is about “15 mm in conveyance direction length×40 mm in width”, and a spacing of 15 mm is provided between the B solid patches 101 and between the Bk solid patches 102 in the conveyance direction of a recording material S.

Moreover, in the first exemplary embodiment, on the first surface charts 103(1-1) and 103(1-2) and the second surface charts 103(2-1) and 103(2-2) of the S chart 103, the B solid patches 101 and the Bk solid patches 102 are arranged not to overlap between the front surface and back surface of the recording material S. The reason for this is to avoid an influence on a detected brightness caused by see-through at the time of reading by the first and second line sensors 91 and 92. This see-through may occur, particularly, in a recording material S with a small grammage.

Moreover, in the first exemplary embodiment, the size of a recording material S that is usable for outputting of a chart is set to greater than or equal to 210 mm (the short side of A4 size) in conveyance direction length and greater than or equal to 160 mm in width. However, the size of a recording material S that is usable for outputting of a chart is not limited to that in the first exemplary embodiment, but can be set as appropriate according to, for example, the maximum passing paper size in the image forming apparatus 1. Moreover, a configuration in which not only recording materials S with standard sizes but also a recording material S with an optional size is used by, for example, the operator inputting and designating the size via the operation unit 70 or the external apparatus 200 can be employed.

Furthermore, in the first exemplary embodiment, the image forming apparatus 1 is configured to be able to select, in the adjustment mode, whether to perform adjustment of only a secondary transfer voltage at the time of one-sided printing (here, also referred to as “one-sided adjustment”) or whether to perform adjustment of secondary transfer voltages for the first surface and the second surface at the time of two-sided printing (here, also referred to as “two-sided adjustment”). However, for ease of understanding of the first exemplary embodiment, in the first exemplary embodiment, the case of performing “two-sided adjustment” is described. The case of performing “one-sided adjustment” is described below in a third exemplary embodiment.

Moreover, the design of a chart is not limited to that in the first exemplary embodiment. For example, the adjustment patches are not limited to a B solid image and a Bk solid image. The adjustment patch can be, for example, any one of the B solid image and the Bk solid image, or can be another single-color solid image, a solid image of another secondary color or color mixture (multiple color), or a halftone image. Moreover, for example, the shapes or number of adjustment patches can be changed depending on, for example, the configuration of the image forming apparatus 1, the size of a recording material S corresponding to outputting of the chart, or the reading method. Moreover, for example, the shape of a trigger patch is also not limited to that in the first exemplary embodiment. Moreover, depending on, for example, the reading method for a chart, a trigger patch is not necessarily required.

Moreover, supposing that, for example, the operator performs a visual check, as identification information indicating setting of a secondary transfer voltage in transferring each patch to a recording material S, information about, for example, a patch number described below can be printed while being associated with patches of each set with regard to the conveyance direction of a recording material S. Moreover, supposing that, for example, the operator performs a visual check, as identification information indicating whether the chart concerned is a chart for adjustment as the first surface chart or a chart for adjustment as the second surface chart, information about, for example, the front surface (first surface chart) or the back surface (second surface chart) can be printed on a corresponding surface.

### <7. Operations in Adjustment Mode>

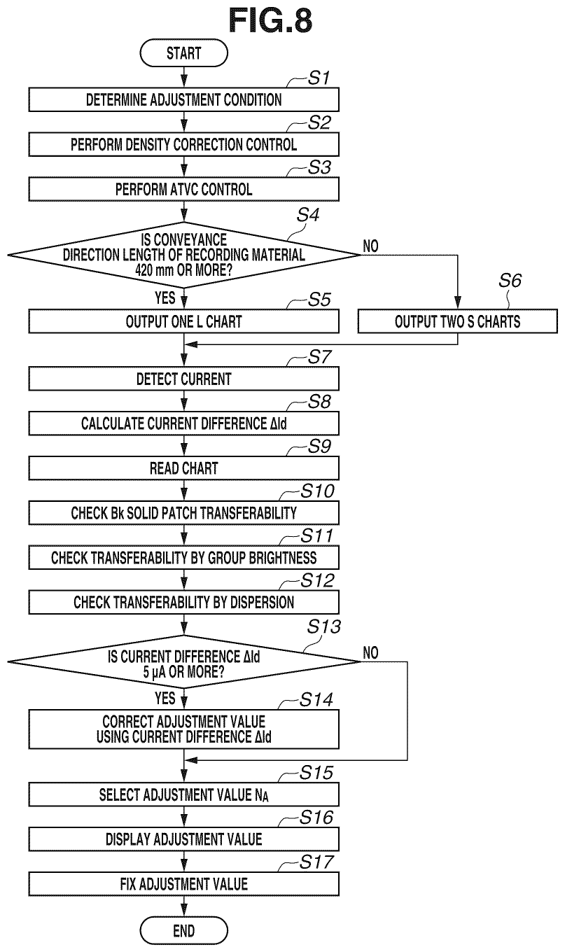

Next, operations in the adjustment mode in the first exemplary embodiment are described. FIG. 8 is a flowchart illustrating the outline of a procedure for the adjustment mode in the first exemplary embodiment. Here, a case where the operator causes the image forming apparatus 1 via the operation unit 70 of the image forming apparatus 1 to execute the adjustment mode is described as an example. The role of the operation unit 70 causing the image forming apparatus 1 to execute the adjustment mode can also be assumed by, for example, the external apparatus 200 such as a personal computer. Moreover, in the following description, characters set forth below are used.
N: adjustment value (=−20 to +20),
N₀: current adjustment value (before execution of the adjustment mode),
N_{A}: selected adjustment value,
n: patch number of adjustment patch (n=1 to 10 (in order from the smaller adjustment value),
n₀: patch number corresponding to the current adjustment value (corresponding to the adjustment value No),
N_{A}: selected patch number (corresponding to the adjustment value N_{A}),
T: character representing a trigger patch, and
D: character representing a position at which to detect the electrical resistance of a location to which air has been blown.

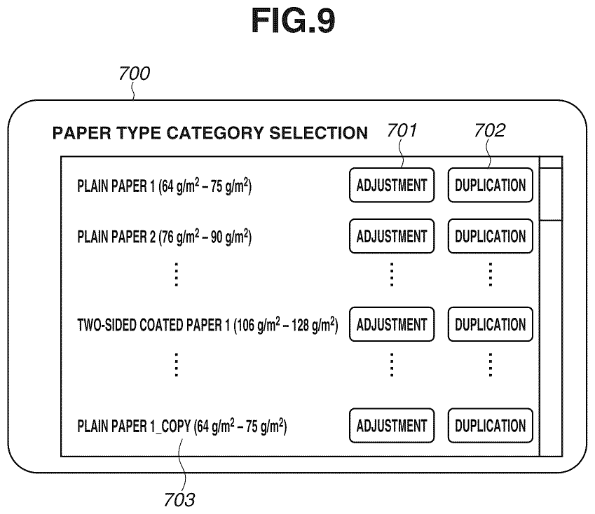

First, in step S1, the control unit 30 (adjustment process unit 31d) acquires information about a recording material S which the operator wants to adjust (the size and paper type category (and grammage) of the recording material S) and information about an adjustment condition, which are input by the operator. FIG. 9 is a schematic diagram of a paper type category selection screen 700, which is displayed on the display unit 70a of the operation unit 70 by control performed by the control unit 30 (adjustment process unit 31d) in step S1. In the paper type category selection screen 700, paper type categories of recording materials S that are able to be set in the image forming apparatus 1 are displayed. The operator presses (operates) an adjustment button 701, thus being able to proceed to an adjustment mode for adjusting a setting voltage for a secondary transfer voltage. Furthermore, a configuration in which, in the paper type category selection screen 700, the operator is able to not only perform an operation for adjusting a setting voltage for a secondary transfer voltage but also access a change screen for another image forming condition, such as a fixing condition, can be employed. Moreover, a configuration in which, to keep remaining the default setting of each paper type category, the operator is able to operate a duplication button 702 to duplicate a paper type category in the RAM 33 or the ROM 32 and then execute the adjustment mode can be employed. The duplicated paper type category 703 is stored as another name in the RAM 33 or the ROM 32, and, with respect to the duplicated paper type category 703, image formation is assumed to be performed in the default setting excluding a condition the setting of which has been changed.

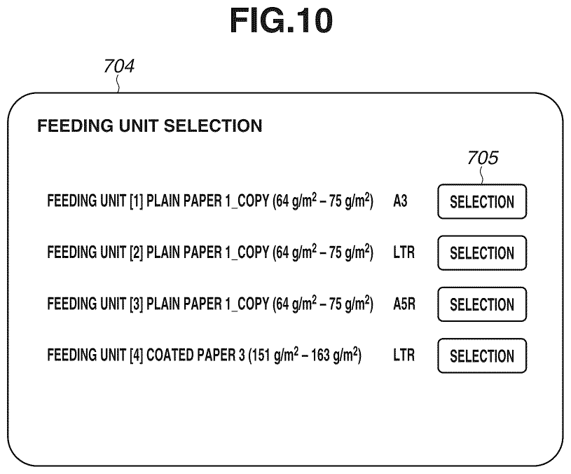

FIG. 10 is a schematic diagram of a feeding unit selection screen 704, which is displayed on the display unit 70a of the operation unit 70 by control performed by the control unit 30 (adjustment process unit 31d) in step S1. In response to the paper type category of a recording material S with respect to which to execute the adjustment mode being selected, the feeding unit selection screen 704 illustrated in FIG. 10 is displayed. In the feeding unit selection screen 704, paper type categories of recording materials S stored in the feeding unit 4 which preliminarily are set via, for example, the operation unit 70 by the operator and sizes detected by a recording material size detection sensor (not illustrated) provided in each feeding unit 4 are displayed. For example, a case where, with “plain paper_1 copy (64 g/m² to 75 g/m²)” being selected, the adjustment mode is executed is described. In the example illustrated in FIG. 10, “plain paper_1 copy (64 g/m² to 75 g/m²)” is stored in a plurality of feeding units (a feeding unit [1], a feeding unit [2], and a feeding unit [3]). Moreover, a configuration in which, in the case of sizes of recording materials S compatible with the adjustment mode, the operator is able to press (operate) a selection button 705 is employed. A configuration in which, in the case of paper type categories incompatible with the adjustment mode and sizes of recording materials S incompatible with the adjustment mode, the selection button 705 is grayed out to disable the operator to press (operate) the selection button 705 can be employed. Moreover, a configuration in which, for example, in a case where a recording material S with respect to which to execute the adjustment mode is preliminarily stored in none of the feeding units 4, the operator is able to press, for example, a back button (not illustrated) to once exit the feeding unit selection screen 704 can be employed.

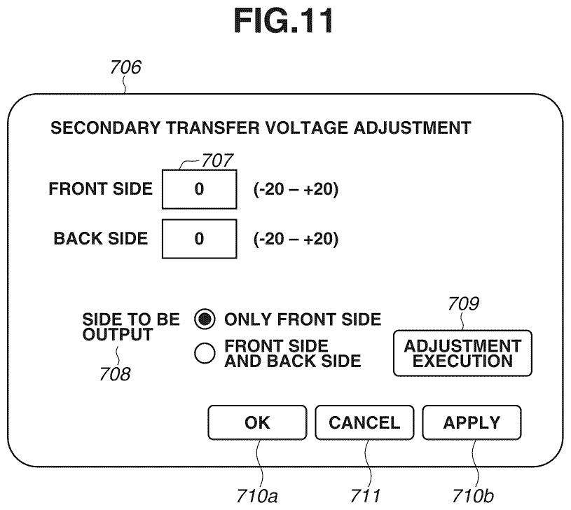

FIG. 11 is a schematic diagram of a secondary transfer voltage adjustment screen 706, which is displayed on the display unit 70a of the operation unit 70 by control performed by the control unit 30 (adjustment process unit 31d) in step S1. In response to a paper type category of a recording material S with respect to which to execute the adjustment mode being selected and a feeding unit 4 in which the selected recording material S is stored being selected, the secondary transfer voltage adjustment screen 706 illustrated in FIG. 11 is displayed. The secondary transfer voltage adjustment screen 706 includes, for example, an adjustment value display portion 707, in which the current adjustment value is displayed, a one-side two-side selection portion 708, which is used to select an execution target for the adjustment from between one side and two sides, and an adjustment execution button 709, which is used to start formation of a chart. In response to a value being input to the adjustment value display portion 707, it becomes possible to perform secondary transfer with a recording material shared voltage being offset from the default recording material shared voltage Vp stored in the ROM 32. In the first exemplary embodiment, in the adjustment value display portion 707, each of integers of −20 to +20 is able to be input as an adjustment value N, and the default value is 0. In a case where the adjustment value N is 0, a default recording material shared voltage Vp corresponding to the paper type category recorded in the ROM 32 is directly used. With regard to a value (adjustment value N) in the adjustment value display portion 707, “ΔN=1” is made to correspond to “ΔV=150 volts (V)”. Thus, as the adjustment value N is changed by 1, the adjustment amount ΔV changes by 150 V. For example, in a case where “N=−5” has been input to the adjustment value display portion 707, a value obtained by offsetting the default recording material shared voltage Vp by −750 V (=−5×150) is used as a recording material shared voltage. In the case of executing the adjustment mode, the operator selects whether to perform one-sided adjustment or two-sided adjustment via the one-side two-side selection portion 708 and then presses (operates) the adjustment execution button 709. However, as mentioned above, in the first exemplary embodiment, the case of performing “two-sided adjustment” is described.

In step S2, in response to the adjustment execution button 709 being pressed (operated), the control unit 30 (adjustment process unit 31d) performs density correction control. The density correction control is performed to, before adjusting the secondary transfer voltage, bring about a state in which a given appropriate amount of toner is applied onto the intermediate transfer belt 44b. The control unit 30 (adjustment process unit 31d) performs control to form a toner patch for density correction control while changing outputs of, for example, the charging power source 73, the developing power source 74, and the exposure device 42 and then primarily transfer the toner patch onto the intermediate transfer belt 44b. Then, the control unit 30 (adjustment process unit 31d) measures the toner amount (density) of the toner patch on the intermediate transfer belt 44b by a patch detection sensor (not illustrated), and thus determines an image forming condition to be used at the time of outputting of a chart. Furthermore, the density correction control does not need to be necessarily performed each time the adjustment mode is executed. A configuration in which the control unit 30 (adjustment process unit 31d) determines whether to perform density correction control based on, for example, the number of sheets used for image formation, a change of environment, or an elapsed time from the time when density correction control was performed the last time can be employed.

Next, in step S3, the control unit 30 (adjustment process unit 31d and ATVC control process unit 31b) performs ATVC control. The details of the ATVC control are as described above.

After that, in step S4 to step S6, the control unit 30 (adjustment process unit 31d) performs control to output a chart. At this time, the control unit 30 (adjustment process unit 31d) performs control to select a chart according to the size of a recording material S and output the selected chart. In step S4, the control unit 30 (adjustment process unit 31d) determines whether the conveyance direction length of the recording material S is greater than or equal to 420 mm. If, in step S4, it is determined that the conveyance direction length of the recording material S is greater than or equal to 420 mm (YES in step S4), then in step S5, the control unit 30 (adjustment process unit 31d) performs control to output one L chart 100 illustrated in FIG. 6. Moreover, if, in step S4, it is determined that the conveyance direction length of the recording material S is less than 420 mm (NO in step S4), then in step S6, the control unit 30 (adjustment process unit 31d) performs control to output two S charts 103 illustrated in FIG. 7. Furthermore, in step S5 and step S6, the control unit 30 (adjustment process unit 31d) performs control to form a chart or charts on one side or two sides of a recording material S according to whether the adjustment mode is one-sided adjustment or two-sided adjustment. However, as mentioned above, in the first exemplary embodiment, the case of performing “two-sided adjustment” is described.

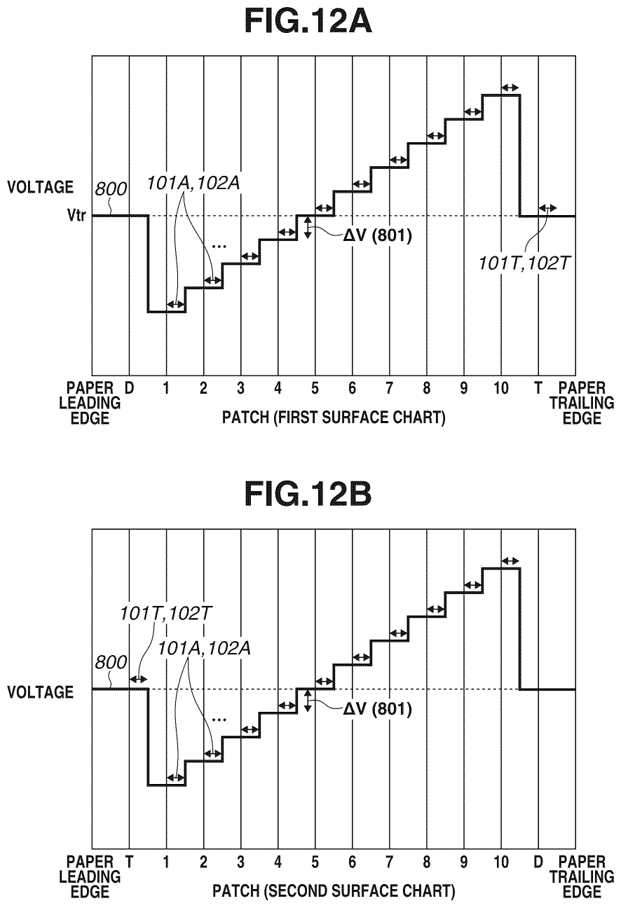

FIGS. 12A and 12B are graphs illustrating transition of an output of the secondary transfer power source 76 at the time of secondarily transferring a chart in the case of an L chart 100 to a recording material S. FIG. 12A illustrates the transition for the first surface chart at the time of two-sided adjustment, and FIG. 12B illustrates the transition for the second surface chart at the time of two-sided adjustment. In the case of the first surface chart, after ten adjustment patches 101A and ten adjustment patches 102A are secondarily transferred to a recording material S in a serial manner, trigger patches 101T and 102T are secondarily transferred to the recording material S. The adjustment patches 101A and 102A are arranged side by side in such a manner that the adjustment value N is sequentially increased in order from a smaller adjustment value N. Furthermore, patch numbers of the adjustment patches 101A and 102A are assumed to increase in association with an increase in the adjustment value N with a patch number equivalent to the smallest adjustment value N being set to “n=1” and a patch number equivalent to the largest adjustment value N being set to “n=10”. Moreover, in the case of the first surface chart, for the recording material shared voltage Vp for setting the secondary transfer voltage Vtr, values in the table stored in the ROM 32 for the first surface chart are used. The timing of switching secondary transfer voltages at the time of secondarily transferring a chart to a recording material S is after each of the patches 101 and 102 has passed through the secondary transfer portion N2. While there is a slight time lag until outputs of the secondary transfer power source 76 are switched, performing switching at the above-mentioned timing causes outputs of the secondary transfer power source 76 to be switched at a white space between two adjacent patches. In the case of the second surface chart, the arrangement of the adjustment patches 101A and 102A and trigger patches 101T and 102T is inverted from that in the first surface chart, and, for the recording material shared voltage Vp, values in the table stored in the ROM 32 for the second surface chart are used. However, switching of secondary transfer voltages and other operations are performed in a similar way to that in the first surface chart.

In the first exemplary embodiment, the variation range (the range of change in one step) ΔV of the secondary transfer voltage (ΔV 801 in FIGS. 12A and 12B) at the time of secondarily transferring a chart to a recording material S is switched according to the secondary transfer portion shared voltage Vb. In the first exemplary embodiment, in a case where the secondary transfer portion shared voltage Vb is higher than or equal to 2,000 V, the variation range ΔV of the secondary transfer voltage is set to 450 V, which is equivalent to the variation range ΔN of the adjustment value=3 (corresponding to three steps of the adjustment value N). Moreover, in a case where the secondary transfer portion shared voltage Vb is higher than or equal to 1,500 V and lower than 2,000 V, the variation range ΔV of the secondary transfer voltage is set to 300 V, which is equivalent to the variation range ΔN of the adjustment value=2 (corresponding to two steps of the adjustment value N). Moreover, in a case where the secondary transfer portion shared voltage Vb is lower than 1,500 V, the variation range ΔV of the secondary transfer voltage is set to 150 V, which is equivalent to the variation range ΔN of the adjustment value=1 (corresponding to one step of the adjustment value N). This is because it is conceivable that, to check the current sensitivity of secondary transferability, making the range of change of a secondary transfer voltage in one step larger as the secondary transfer portion shared voltage Vb is larger is able to widen the range of change of a secondary transfer current in the whole chart and is thus more efficient. While, in the first exemplary embodiment, the variation range ΔV of the secondary transfer voltage (the variation range ΔN of the adjustment value) at the time of secondarily transferring a chart to a recording material S is made to be automatically selected according to a result of ATVC control, a configuration in which the operator is able to directly select the variation range ΔV of the secondary transfer voltage via, for example, the secondary transfer voltage adjustment screen 706 can be employed. Additionally, a configuration in which the operator is able to select whether to set the variation range ΔV of the secondary transfer voltage (the variation range ΔN of the adjustment value) at the time of secondarily transferring a chart to a recording material S to “being automatically selected” or “being directly designated” can be employed.

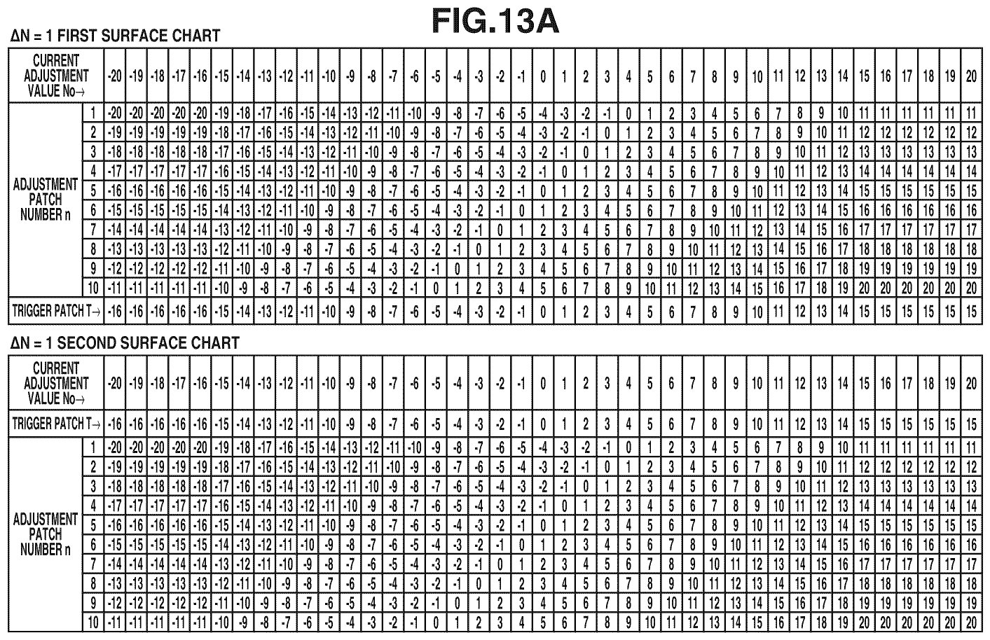

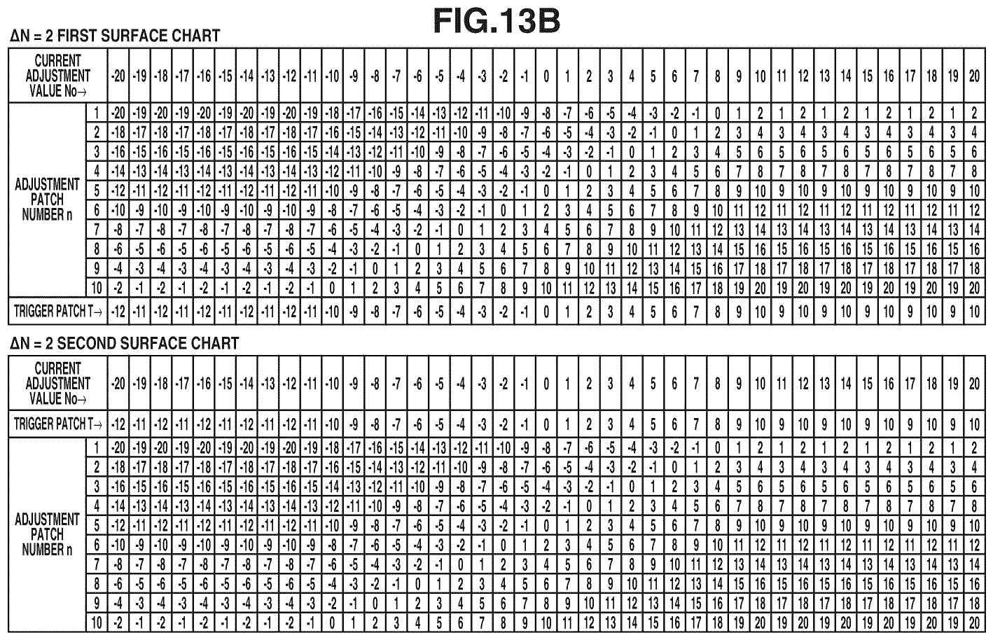

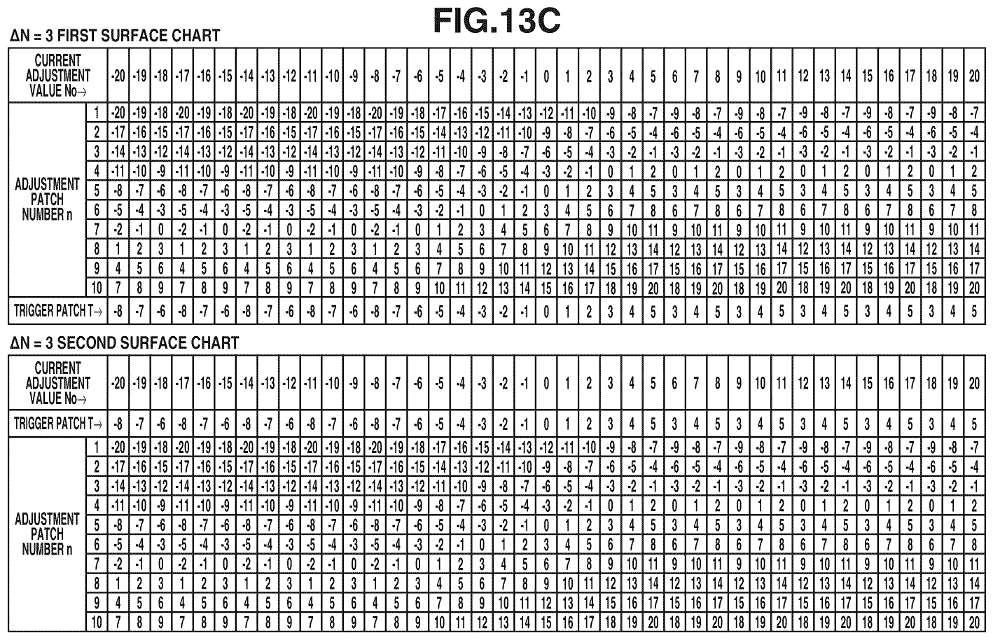

FIG. 13A, FIG. 13B, and FIG. 13C illustrate lists of current adjustment values No and adjustment values N of secondary transfer voltages to be applied with respect to the respective patch numbers n for each of the variation ranges ΔN of the adjustment value (the variation ranges ΔV of the secondary transfer voltage) and for each of the first surface chart and the second surface chart in the first exemplary embodiment. FIG. 13A illustrates the case of the variation range ΔN of the adjustment value=1, FIG. 13B illustrates the case of the variation range ΔN of the adjustment value=2, and FIG. 13C illustrates the case of the variation range ΔN of the adjustment value=3. In a case where the current adjustment value No is 0, the patch number n=5 corresponds to the current adjustment value N₀=0, the patch numbers n=1 to 4 correspond to the side of small adjustment values in increments of the variation ranges ΔN, and the patch numbers n=6 to 10 correspond to the side of large adjustment values in increments of the variation ranges ΔN. In cases other than the case where the current adjustment value N₀ is 0, the adjustments values corresponding to the respective adjustment patches 101A and 102A are uniformly offset.

Moreover, if the current adjustment value No is fixed to “n=5”, in a case where the current adjustment value N₀=is large on the plus side or the minus side, there occurs a case where not all of the adjustments patches 101A and 102A for “n=1 to 10” fit into the adjustment range of ±20. In such a case, shifting the patch corresponding to the current adjustment value N₀ from “n=5” causes all of the adjustments patches 101A and 102A for “n=1 to 10” to fit into the adjustment range of ±20. This enables effectively utilizing all of the adjustments patches 101A and 102A.

In the case of the L chart 100, at the time of secondarily transferring a chart to a recording material S, the trigger patches 101T and 102T are present on each of the paper trailing edge side of the first surface chart and the paper leading edge side of the second surface chart. The trigger patches 101T and 102T are used for position detection of a patch at the time of reading of the chart by the sensing unit 3. Therefore, the trigger patches 101T and 102T are required to be transferred at a minimum necessary density for that purpose. An extremely high secondary transfer voltage or an extremely low secondary transfer voltage is at risk of disabling reading of the trigger patches 101T and 102T. Therefore, in the first exemplary embodiment, at the time of secondarily transferring the trigger patches 101T and 102T to a recording material S, a voltage corresponding to the patch number n=5 (a voltage indicated by the dashed line 800 in FIGS. 12A and 12B) is applied.

Moreover, in the case of the L chart 100, at the time of secondarily transferring a chart to a recording material S, a white background portion (white space portion) in which no patch 101 is formed within an image forming region (a region which allows a toner image to be formed therein) is present on each of the paper leading edge side of the first surface chart and the paper trailing edge side of the second surface chart. In the first exemplary embodiment, in this white background portion, a region for acquiring information about the electrical resistance of the vicinity of the front end of a recording material S in the conveyance direction at the time of the recording material S being sent from the feeding unit 4 is set as described below. In the first exemplary embodiment, when the region for acquiring information about the electrical resistance of the vicinity of the front end of a recording material S in the conveyance direction at the time of the recording material S being sent from the feeding unit 4 (hereinafter also referred to as a “position D (or an electrical resistance detection position D)” passes through the secondary transfer portion N2, a voltage corresponding to the patch number n=5 (a voltage indicated by the dashed line 800 in FIGS. 12A and 12B) is applied.

In this way, in the first exemplary embodiment, when the position at which the trigger patches 101T and 102T are present of a recording material S and the position D of the vicinity of the front end of a recording material S in the conveyance direction at the time of the recording material S being sent from the feeding unit 4 pass through the secondary transfer portion N2, a voltage corresponding to the patch number n=5 (a voltage indicated by the dashed line 800 in FIGS. 12A and 12B) is applied. Particularly, in the first exemplary embodiment, a voltage corresponding to the patch number n=5 (a voltage indicated by the dashed line 800 in FIGS. 12A and 12B) is applied to the almost entire area of a region other than the adjustment patches 101A and 102A within an image forming region of the recording material S in the conveyance direction at the time of the recording material S passing through the secondary transfer portion N2.

Furthermore, the method of setting a secondary transfer voltage to be applied at the time of transferring the trigger patches 101T and 102T to a recording material S is not limited to the above-described method in the first exemplary embodiment. For example, a method of setting the secondary transfer voltage to a relatively high voltage (relatively large absolute value) to at the very least prevent or reduce weak or missing printing (transfer failure due to a transfer voltage being weak) or a method of performing constant current control of a secondary transfer voltage to perform transfer at a minimum necessary density is conceivable. Similarly, the voltage to be applied at the position D is also not limited to the voltage set in the first exemplary embodiment. The voltage to be applied at the position D only needs to enable acquiring, with a sufficient degree of accuracy, information about the electrical resistance of the vicinity of the front end of a recording material S in the conveyance direction at the time of the recording material S being sent from the feeding unit 4 (in more detail, a current difference ΔId described below). This voltage can be set to a voltage higher (larger in absolute value) than the voltage corresponding to the patch number n=5 or a voltage lower (smaller in absolute value) than the voltage corresponding to the patch number n=5 (see the second exemplary embodiment). Moreover, it can be favorable, from the viewpoint of simplified control, that this voltage is the same value as a voltage corresponding to any patch number n, and this voltage can be a different value.

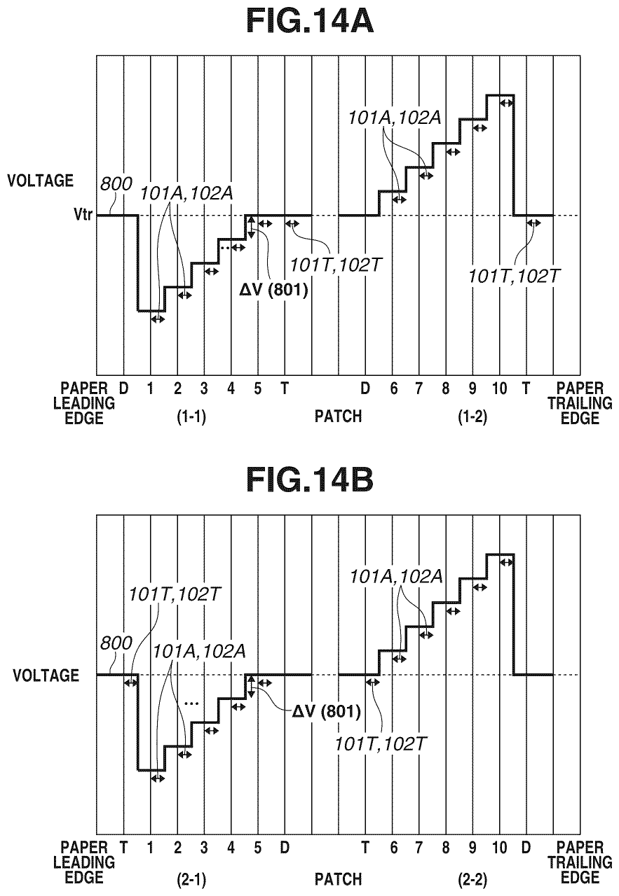

FIGS. 14A and 14B are graphs illustrating transition of an output of the secondary transfer power source 76 at the time of secondarily transferring a chart in the case of an S chart 103 to a recording material S. FIG. 14A illustrates the transition for the first surface chart at the time of two-sided adjustment, and FIG. 14B illustrates the transition for the second surface chart at the time of two-sided adjustment. The S chart 103 is divided into the first surface chart 103(1-1) of the first recording material S, the first surface chart 103(1-2) of the second recording material S, the second surface chart 103(2-1) of the first recording material S, and the second surface chart 103(2-2) of the second recording material S, and the trigger patches 101T and 102T are arranged and the position D is set in each surface chart. However, even in the case of the S chart 103, the magnitude and timing of an output of the secondary transfer power source 76 are set in operations basically similar to those in the case of the L chart 100. Furthermore, the position D can be set in only one of the first recording material S and the second recording material S, such as only the first recording material S.

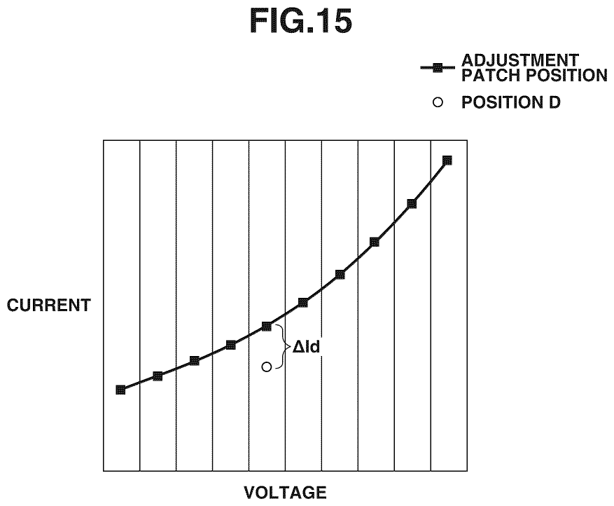

Moreover, in step S7, at the time of outputting of a chart, the control unit 30 (adjustment process unit 31d) performs control to cause the current detection sensor 76b to detect a current flowing when the recording material S passes through the secondary transfer portion N2. The timing of detecting the current is timing at which the positions to which the adjustment patches 101A and 102A of the patch numbers 1 to 10 of the recording material S (hereinafter also referred to as “adjustment patch positions 1 to 10”, respectively) are transferred are passing through the secondary transfer portion N2. Moreover, the timing of detecting the current is timing at which the position D of the recording material S is passing through the secondary transfer portion N2. Moreover, the timing of detecting the current is timing at which the position to which the trigger patches 101T and 102T of the recording material S are transferred (hereinafter also referred to as “trigger patch position T”) is passing through the secondary transfer portion N2. Furthermore, currents can be detected a plurality of times during a period when the above-mentioned respective positions (regions) are passing through the secondary transfer portion N2, and the average value of the detected currents can be used for control as a detection result of current obtained when each position (region) is passing through the secondary transfer portion N2. Each of the adjustment patch positions 1 to 10, the trigger patch position T, and the position D is assumed to be represented by the median thereof in the conveyance direction of a recording material S. This enables the control unit 30 (adjustment process unit 31d) to acquire a relationship between voltage and current obtained at the time of outputting of a chart. FIG. 15 is a graph illustrating a relationship between voltage and current (voltage-current characteristic) which is acquired at the time of outputting of a chart in the first exemplary embodiment.

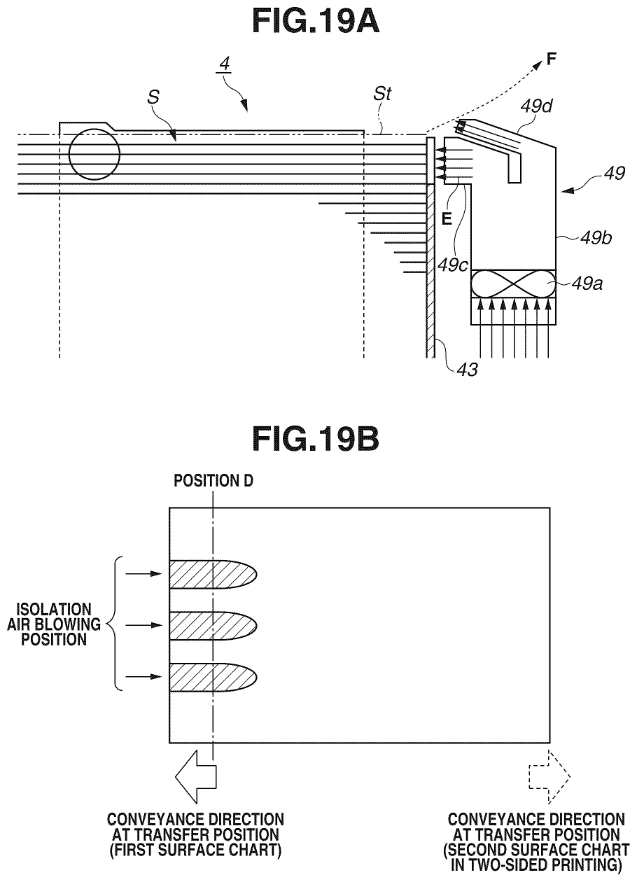

Here, the position D is set in such a way as to include a location to which air has been blown in the feeding unit 4 near the front end of a recording material S in the conveyance direction at the time of the recording material S being sent from the feeding unit 4. FIG. 19A is a schematic sectional view of the vicinity of the air blowing unit 49 of the feeding unit 4 (a cross-section approximately perpendicular to the rotational axis direction of the photosensitive drum 51) in the first exemplary embodiment. Moreover, FIG. 19B is a schematic diagram illustrating the position to which air is blown of a recording material S in the feeding unit 4 in the first exemplary embodiment. The air blowing unit 49 is configured to include, for example, a fan 49a, a duct 49b, and an isolation nozzle 49c. When a feeding operation for a recording material S is started by control performed by the control unit 30, the fan 49a is caused to operate, so that air is suctioned into the duct 49b. Then, the suctioned air is blown from the isolation nozzle (blowing port) 49c to some of upper recording materials S including the uppermost recording material S included in a stack of recording materials S contained in the cassette 43. At this time, air is blown to the leading edge portion of a recording material S in the conveyance direction at the time of the recording material S being sent from the feeding unit 4, in a direction leading from the leading edge side toward the trailing edge side as indicated by arrow E. Moreover, in the first exemplary embodiment, the isolation nozzle 49c is provided at a plurality of locations (in the first exemplary embodiment, three locations, i.e., at the central portion and near both end portions) in the width direction of a recording material S. In response to air being blown, several recording materials S including the uppermost recording material S included in a stack of recording materials S contained in the cassette 43 float. Then, the uppermost recording material St is sent from the cassette 43 as indicated by arrow F by the feeding member 48 (FIG. 1), such as a feeding roller or a feeding belt. Furthermore, the air blowing unit 49 can further include a separation nozzle 49d which blows air in such a way as to further separate recording materials S isolated by air blown from the isolation nozzle 49c.

As illustrated in FIG. 19B, the location Sa to which air has been blown of a recording material S may be dried by air and may become higher in electrical resistance than a location Sb other than the location Sa. Therefore, the position D is set at a position including the location Sa to which air has been blown in the conveyance direction at the time of the recording material S being sent from the feeding unit 4 (the position at which the electrical resistance of a recording material S may increase in response to air being blown thereto at the time of feeding), and a voltage is applied to the secondary transfer outer roller 45b when the position D passes through the secondary transfer portion N2 and a current is detected by the current detection sensor 76b. This enables comparing the electrical resistance of a recording material S in the position D with the electrical resistance of a recording material S in the adjustment patch position to which air is not blown and thus determining whether an electrical resistance unevenness is occurring in the surface of a recording material S due to blowing of air.

Furthermore, while toner is applied to the adjustment patch position, with regard to the electrical resistances of a recording material S and toner when the adjustment patch position passes through the secondary transfer portion N2, the electrical resistance of toner is sufficiently smaller than the electrical resistance of a recording material S. Therefore, the presence or absence of toner in the position D and the adjustment patch position is ignorable in determining an electrical resistance unevenness in the surface of a recording material S. Detecting the electrical resistance (a current flowing in response to a predetermined voltage being applied) of a recording material S at the adjustment patch position and the position D enables detecting an unevenness of electrical resistance relative to a region to which an adjustment patch is transferred and more accurately performing correction of the adjustment value described below. Moreover, detecting the electrical resistance (a current flowing in response to a predetermined voltage being applied) in an image forming region of the recording material S enables more accurately adjusting a setting voltage for a secondary transfer voltage in transferring a toner image to the recording material S at the time of image formation.

In the first exemplary embodiment, the control unit 30 (adjustment process unit 31d) compares a relationship between the voltages applied and currents detected at the adjustment patch positions 1 to 10 (in the first exemplary embodiment, a polynomial, particularly, a quadratic) with a relationship between the voltage applied and current detected at the position D. Then, in step S8, the control unit 30 (adjustment process unit 31d) calculates a current difference ΔId and stores the calculated difference ΔId in the RAM 33. It can be determined that, as the current difference ΔId is larger, the electrical resistance of a recording material S becomes locally higher due the influence of air. In more detail with reference to FIG. 15, the control unit 30 (adjustment process unit 31d) obtains a relationship between the voltages applied and currents detected at the adjustment patch positions 1 to 10 by approximating the relationship by a quadratic function (I=a×V²+b×V+c). Then, the control unit 30 (adjustment process unit 31d) is able to calculate the current difference ΔId by the following equation where the current detected with the voltage Vtr being applied at the position D is denoted by Id:

ΔId=(a×Vtr²+b×Vtr+c)−Id.

In the case of two-sided adjustment, a relationship between the voltages applied and currents detected at the adjustment patch positions 1 to 10 and the current difference ΔId are acquired and calculated in each of the first surface chart and the second surface chart. Furthermore, in the case of the S chart 103, for example, in each of the first surface chart and the second surface chart, a current detected at the position D in one of the first surface chart and the second surface chart can be used, or an average value of the currents detected at the positions D in the first surface chart and the second surface chart can be used. Moreover, in each of the first surface chart and the second surface chart, the current detected only at the position D in any one of the first surface chart and the second surface chart can be used. Normally, the degrees of occurrence of an electrical resistance unevenness in the surfaces of the first recording material S and the second recording material S, which are serially fed for outputting of S charts 103, can be deemed to be equal to each other.

As mentioned above, the position D is set to the position including the location Sa to which air has been blown near the leading edge in the conveyance direction at the time of the recording material S being sent from the feeding unit 4. From the viewpoint of a relationship to a configuration for effectively performing air isolation, to accurately detect an electrical resistance unevenness in the surface of a recording material S due to blowing of air, it is favorable that the position D is present within a range from the leading edge of a recording material S in the conveyance direction at the time of the recording material S being sent from the feeding unit 4 to 50 mm toward the trailing edge side. In the first exemplary embodiment, the position D is set to the position from the leading edge of a recording material S in the conveyance direction at the time of the recording material S being sent from the feeding unit 4 to 20 mm toward the trailing edge side (in more detail, for example, a region in which, with the position being set to the center in the conveyance direction of a recording material S, the length in the conveyance direction is 15 mm).

In step S9, after a chart is output, the control unit 30 (adjustment process unit 31d) performs control to cause the sensing unit 3 to read the chart and calculate the brightness and dispersion of each of the adjustment patches 101A and 102A in the following way.

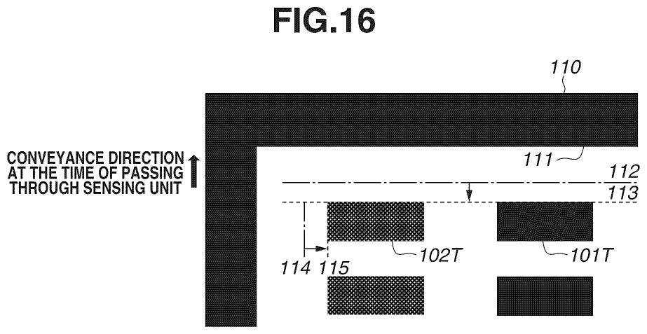

The first and second line sensors 91 and 92 of the sensing unit 3 read the first surface chart and the second surface chart, respectively, at a resolution of 300 dpi. Furthermore, pieces of information about images read by the first and second line sensors 91 and 92 of the sensing unit 3 are then stored in the RAM 33. The control unit 30 (adjustment process unit 31d) calculates the position of each of the adjustment patches 101A and 102A in the following way based on the positions of the trigger patches 101T and 102T of each chart. FIG. 16 is a schematic diagram used to explain an example of a method of identifying the positions of the trigger patches 101T and 102T based on an image 110 read by each of the first and second line sensors 91 and 92. First, the control unit 30 (adjustment process unit 31d) sets, based on a rough positional relationship, a line 112 located in a white space portion between the edge 111 of the chart (recording material S) and the trigger patches 101T and 102T in the conveyance direction of a recording material S at the time of the recording material S passing through the inside of the sensing unit 3. Then, the control unit 30 (adjustment process unit 31d) reads out an average brightness value of the line 112 from information about the read chart. At this time, if the average brightness value is smaller than a preliminarily determined threshold value (the density is larger than a predetermined value), the control unit 30 (adjustment process unit 31d) determines that the line 112 is an edge of the trigger patch 101T or 102T. If it is not determined that the line 112 is an edge of the trigger patch 101T or 102T, the control unit 30 (adjustment process unit 31d) repeats reading of the average brightness value on a line-by-line basis toward the upstream side in the conveyance direction of a recording material S at the time of the recording material S passing through the inside of the sensing unit 3, and thus finds an edge line 113. Next, the control unit 30 (adjustment process unit 31d) sets, based on a rough positional relationship, a line 114 located in a white space portion between the edge 111 of the chart (recording material S) and the trigger patches 101T and 102T in the width direction. Then, the control unit 30 (adjustment process unit 31d) reads out an average brightness value of the line 114 from information about the read chart. At this time, if the average brightness value is smaller than a preliminarily determined threshold value (the density is larger than a predetermined value), the control unit 30 (adjustment process unit 31d) determines that the line 114 is an edge of the trigger patch 101T or 102T. If it is not determined that the line 114 is an edge of the trigger patch 101T or 102T, the control unit 30 (adjustment process unit 31d) repeats reading of the average brightness value on a line-by-line basis toward the right side in the width direction in FIG. 16, and thus finds an edge line 115. The above-mentioned right side in the width direction in FIG. 16 is the right side in the case of viewing the surface facing the first or second line sensor 91 or 92 of a recording material S with the leading edge side in the conveyance direction of a recording material S at the time of the recording material S passing through the inside of the sensing unit 3 being set as a top. Furthermore, the above-mentioned edge detection method is merely an example, and edge detection is not limited to the above-mentioned method. For example, a method different from that in the first exemplary embodiment can be employed depending on a design of the chart.

After completion of identifying the position of each of the adjustment patches 101A and 102A, the control unit 30 (adjustment process unit 31d) calculates an average brightness value and a dispersion value and stores the calculated average brightness value and dispersion value in the RAM 33. Thus, with respect to the n-th adjustment patch, an average brightness value and a dispersion value calculated by the following equations are then stored in the RAM 33:
B (m): the brightness of a pixel read out for the m-th time,
M: the total number of pixels to be read out, and
m=1 to M (reading out for M pixels),

Average brightness value: Bₐᵥₑ(n)=1/M×Σₘ₌₁^{M}B(m), and

Dispersion value: D(n)=1/M×Σₘ₌₁^{M}(B(m)−Bₐᵥₑ(n))².

The average brightness value (brightness average value) is a parameter close to the density (thus, correlated to the density). Moreover, it turned out based on the inventors' consideration that the dispersion value is a parameter having sensitivity to transferability in a case where the surface of a recording material S is rough. In the first exemplary embodiment, calculation of the average brightness value and the dispersion value is performed in both the B solid patch 101 and the Bk solid patch 102. In the first exemplary embodiment, a recommended adjustment amount ΔV for a setting voltage for a secondary transfer voltage (in more detail, an adjustment value N corresponding to the adjustment amount ΔV) is obtained with use of the average brightness value and the dispersion value.

In the first exemplary embodiment, as the brightness to be read out from information about an image read by the sensing unit 3, B brightness is used with respect to the B solid patch 101 and G brightness is used with respect to the Bk solid patch 102. Which of R, G, and B brightness values to use does not need to be as mentioned above, and an average value of three brightness values or grayscale brightness, which is not resolved into R, G, and B, can be used.

Moreover, while, to calculate the dispersion value, it is necessary to temporarily store the read-out brightness of each pixel, this may lead to a high load being put on the control unit 30 and a period for the adjustment mode being increased.

In such a case, a configuration in which brightness values of 0 to 255 are divided into several classifications, the frequency for each pixel is counted, and the dispersion value is calculated from a digital histogram can be employed. Into how many classifications to divide brightness values or how to set an interval of classifications can be changed as appropriate according to the characteristics of the first and second line sensors 91 and 92 or the processing capability of the control unit 30. Moreover, since a brightness histogram varies depending on paper type categories, the number of classifications into which brightness values are divided or the procedure to set an interval of classifications can be changed depending on paper type categories.

Next, in step S10 to step S12, the control unit 30 (adjustment process unit 31d) performs control to select a patch which is favorable in transferability in the following way based on the average brightness values and dispersion values of the adjustment patches 101A and 102A. Furthermore, in the description of processing for selecting a patch which is favorable in transferability, the B solid patch 101 and the Bk solid patch 102 are assumed to be the adjustment patches 101A and 102A, respectively.

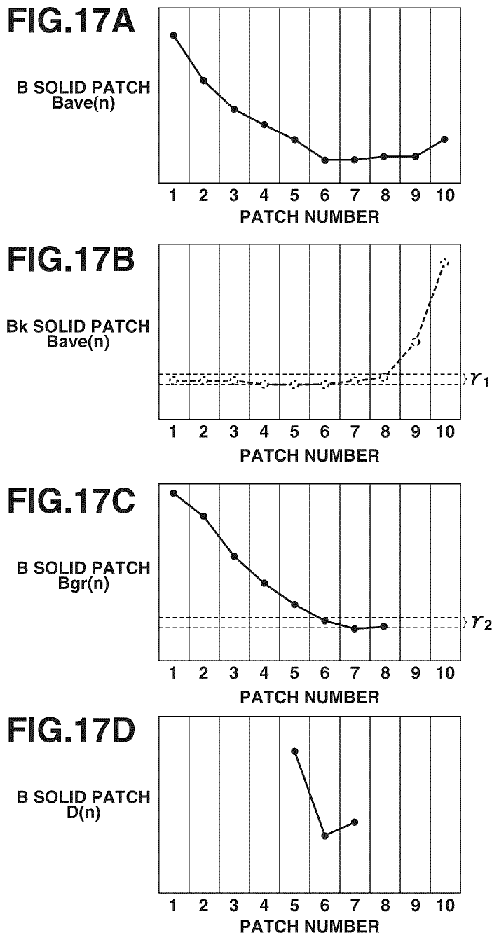

FIG. 17A illustrates an example of an acquisition result of the average brightness value of the B solid patch 101, and FIG. 17B illustrates an example of an acquisition result of the average brightness value of the Bk solid patch 102. Moreover, FIG. 17C illustrates an example of an acquisition result of the average brightness value of the B solid patch 101 grouped as described below, and FIG. 17D illustrates an example of an acquisition result of the dispersion value of the B solid patch 101.

First, in step S10, the control unit 30 (adjustment process unit 31d) looks for the lowest average brightness value from among the Bk solid patches 102. Then, the control unit 30 (adjustment process unit 31d) performs control to narrow down to patch numbers (i.e., adjustment values) falling into a range of preliminarily set threshold value γ₁ in order of increasing brightness from the lowest average brightness value. In the case of the example illustrated in FIG. 17B, the patch numbers corresponding to the lowest average brightness value are n=4, 5, and 6, and the patch numbers to which narrowing down is performed are n=1, 2, 3, 4, 5, 6, 7, and 8. This enables narrowing down to patch numbers (i.e., adjustment values) in which Bk solid patches are able to be transferred to some extent. The threshold value γ₁ can be made smaller in the case of giving importance to the transferability of a Bk solid patch, and can be made larger in the case of giving importance to the transferability of a B solid patch.

Next, in step S11, the control unit 30 (adjustment process unit 31d) calculates an average brightness value (here, also referred to as “group brightness”) of three B solid patches 101 including patch numbers before and after a B solid patch 101 of each patch number (i.e., adjustment value) to which narrowing down has been performed. Then, the control unit 30 (adjustment process unit 31d) selects a set (group) which is low in the calculated group brightness. The group brightness corresponding to the n-th patch is expressed by the following equation:
Group brightness: B_{gr}(n),

B_{gr}(n)=(Bₐᵥₑ(n−1)+Bₐᵥₑ(n)+Bₐᵥₑ(n+1))/3.

FIG. 17A illustrates the average brightness value of the B solid patch 101, and FIG. 17C illustrates the value obtained by converting the average brightness value of the B solid patch 101 into the group brightness. In the case of the example illustrated in FIG. 17C, the group brightness of a group of patch number n=7 (i.e., patch numbers n=6, 7, and 8) is the lowest.

Here, in the case of adjustment using a chart, it is possible to perform adjustment only with respect to patches with given densities.

Therefore, the control unit 30 (adjustment process unit 31d) can perform correction to the group which has been selected here. For example, the control unit 30 (adjustment process unit 31d) preliminarily sets a threshold value γ₂ for the lowest group brightness. Then, the control unit 30 (adjustment process unit 31d) checks whether there is a group brightness which falls into a range of the threshold value γ₂ in order of increasing brightness from the lowest group brightness in the patch numbers (i.e., adjustment values) smaller than the patch number of the group with the lowest group brightness. Then, if there is such a group brightness, the control unit 30 (adjustment process unit 31d) can change the group targeted for selection to a group of the patch number (i.e., adjustment value) of such a group brightness. By this correction, the control unit 30 (adjustment process unit 31d) is able to select the patch number (i.e., adjustment value) of a group as close as possible to the rising of transferability of secondary color. This enables preventing or reducing the occurrence of a case where, with respect to a user who focuses on outputting of a monochrome image or a halftone image, the secondary transfer voltage Vtr is too high. In the first exemplary embodiment, the correction (front loading) of an adjustment value using the threshold value Y2 such as that mentioned above is employed. Then, in the case of the example illustrated in FIG. 17C, the group of the patch number n=6 (i.e., patches of the patch numbers n=5, 6, and 7) is selected.

Next, in step S12, the control unit 30 (adjustment process unit 31d) selects a patch with the lowest dispersion value included in the selected group. In the case of the example illustrated in FIG. 17D, the dispersion value in the patch number n=6 is the lowest.

Furthermore, the above-described processing for selecting an adjustment value in the present flowchart is merely an example, and another example of the processing is also conceivable. For example, the group brightness B_{gr} has been calculated using three patches, but can be calculated using four or more patches or can be calculated using two patches. While the group brightness B_{gr} is effective for selecting an adjustment range which is stably favorable in transferability, without using the group brightness B_{gr}, an adjustment value can be directly selected from the average brightness value and the dispersion value. Particularly, while, depending on setting of the threshold value γ₁ or transferability of a recording material S, a group brightness may not be able to be selected, in that case, without using the group brightness, an adjustment value can be directly selected from the average brightness value and the dispersion value. Moreover, the dispersion value is effective for detecting a density unevenness in an adjustment patch, but does not necessarily need to be used. Moreover, the transferability of the Bk solid patch can be adjusted by a method other than narrowing-down using the threshold value γ₁.

For example, a patch number (i.e., adjustment value) in which the average brightness value of the Bk solid patch is the lowest (density is the highest) and the average brightness value of the B solid patch is the lowest (density is the highest) can be selected.

Next, in step S13, the control unit 30 (adjustment process unit 31d) compares the current difference ΔId stored in the RAM 33 in step S8 with a predetermined threshold value. In a case where the current difference ΔId is greater than or equal to the predetermined threshold value, it is determined that the degree of dryness of a recording material S due to air at the time of feeding is large, the electrical resistance of a location to which air has been blown becomes higher than those of the other locations, and, therefore, an electrical resistance unevenness is occurring in the surface of the recording material S. In that case, even if the adjustment value selected before this is used, the location to which air has been blown may become deficient in transfer current. Therefore, if, in step S13, it is determined that the current difference ΔId is greater than or equal to the predetermined threshold value (YES in step S13), then, in step S14, the control unit 30 (adjustment process unit 31d) performs correction to the adjustment value selected before this.

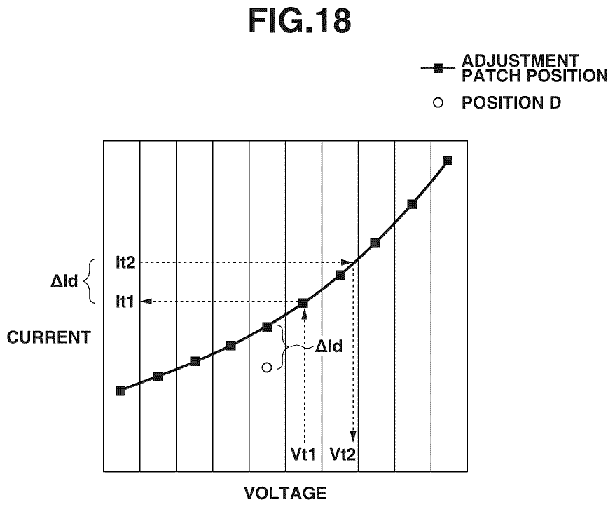

FIG. 18 is a graph used to explain a method of correcting an adjustment value using the current difference ΔId in the first exemplary embodiment. FIG. 18 illustrates a relationship (voltage-current characteristic) between voltage and current which is acquired at the time of outputting of a chart as with the graph illustrated in FIG. 15. A voltage value corresponding to the adjustment value selected in step S12 is denoted by Vt1. The control unit 30 (adjustment process unit 31d) applies the voltage value Vt1 to a relationship between the voltages applied and currents detected at the adjustment patch positions 1 to 10 (I=a×V²+b×V+c) and thus calculates a current value It1 of the current flowing in conformity with the voltage value Vt1. Thus, the current value It1 is calculated by the following equation:

It1=a×Vt1²+b×Vt1+c.

Moreover, the control unit 30 (adjustment process unit 31d) calculates a corrected current value It2 obtained by adding the current difference ΔId to the calculated current value It1. Thus, the current value It2 is calculated by the following equation:

It2=It1+ΔId.

Moreover, the control unit 30 (adjustment process unit 31d) applies the current value It2 to a relationship between the voltages applied and currents detected at the adjustment patch positions 1 to 10 (I=a×V²+b×V+c) and thus calculates a corrected voltage value Vt2. Thus, the voltage value Vt2 satisfying the following equation is calculated:

It2=a×Vt2²+b×Vt2+c.

Then, in step S15, the control unit 30 (adjustment process unit 31d) finally selects, as a recommended adjustment value, an adjustment value N_{A} corresponding to the patch number n_{A} of the patch to which a voltage closest to the voltage value Vt2 has been applied. In the case of two-sided adjustment, the correction of an adjustment value using the current difference ΔId is performed on each of the first surface chart and the second surface chart with use of current detection results obtained in the respective first and second surface charts. Furthermore, if, in step S13, it is determined that the current difference ΔId is less than the predetermined threshold value (NO in step S13), the control unit 30 (adjustment process unit 31d) determines that the influence of air at the time of feeding is small (an electrical resistance unevenness in the surface of a recording material S is within the acceptable range) and thus does not correct the adjustment value selected before this. In the first exemplary embodiment, the predetermined threshold value for the current difference ΔId is set to 5 microampere (μA). Thus, in the first exemplary embodiment, in a case where the current difference ΔId is greater than or equal to 5 μA, then in step S14, the control unit 30 (adjustment process unit 31d) corrects the adjustment value selected in step S12, and then in step S15, the control unit 30 (adjustment process unit 31d) employs the corrected adjustment value as a recommended adjustment value N_{A}. On the other hand, in the first exemplary embodiment, in a case where the current difference ΔId is less than 5 μA, the control unit 30 (adjustment process unit 31d) directly employs the adjustment value selected in step S12 as a recommended adjustment value N_{A}.

In step S16, the control unit 30 (adjustment process unit 31d) causes the display unit 70a of the operation unit 70 to display the adjustment value N_{A} selected in the above-described way in the adjustment value display portion 707 of the secondary transfer voltage adjustment screen 706 such as that illustrated in FIG. 11. The operator determines whether the content displayed in the secondary transfer voltage adjustment screen 706 is good, and, in the case of not changing the displayed adjustment value N_{A}, the operator selects a confirmation portion 710 (an OK button 710a or an apply button 710b). On the other hand, in the case of wanting to change the displayed adjustment value N_{A}, the operator performs inputting to the adjustment value display portion 707 by operating, for example, a numeric keypad (not illustrated) of the operation unit 70 and then selects the confirmation portion 710 (the OK button 710a or the apply button 710b). By, for example, visually checking the chart which has been output, the operator is able to determine whether the above-mentioned content displayed in the secondary transfer voltage adjustment screen 706 is good. In a case where the adjustment value has been changed, in step S17, the control unit 30 (adjustment process unit 31d) stores an adjustment value input by the operator in the RAM 33 (or the secondary transfer voltage storage unit/computation unit 31f).

On the other hand, if the confirmation portion 710 has been selected without the adjustment value being changed, in step S17, the control unit 30 (adjustment process unit 31d) directly stores the adjustment value determined in the above-described way in the RAM 33 (or the secondary transfer voltage storage unit/computation unit 31f). Then, the adjustment mode ends.

### <8. Advantageous Effect>

An experiment for confirming the advantageous effect of the first exemplary embodiment was performed with respect to the first exemplary embodiment and a comparative example. In the comparative example, an adjustment mode under the condition of not performing correction of an adjustment value using a current detection result of a location to which air had been blown at the time of feeding was executed.

In the experiment, heavy paper with a grammage of 300 grams per square meter (g/m²) was used as a recording material S. This is because the case of using heavy paper with a grammage larger than that of plain paper as a recording material S easily makes the difference of electrical resistance conspicuous between a location to which air has been blown at the feeding unit 4 and the other locations and exhibits the tendency that the difference of transferability caused by an electrical resistance unevenness is likely to occur. Table 1 set forth below shows adjustment values obtained after execution of the adjustment mode and image qualities of a central portion of the surface of the recording material S and a location of the recording material S to which air has been blown at the time of feeding. With regard to the image quality, the case where there is no problem is represented by “∘ (good)” and the case where an image defect caused by setting of a secondary transfer voltage has occurred is represented by “x (defect)”. Furthermore, similar results were obtained with regard to the first surface chart and the second surface chart in two-sided printing, one of results obtained in the first surface chart and the second surface chart is shown as a representative thereof in Table 1.

TABLE 1

| | First exemplary | Comparative |
|---|---|---|
| | embodiment | example |
| Adjustment value | +2 | +1 |
| Recording material central portion | ∘ | ∘ |
| Portion to which air has been applied | ∘ | x (transfer |
| of recording material | | voids) |

In the comparative example, an adjustment value which leads to a secondary transfer voltage somewhat lower than that in the first exemplary embodiment was selected due to the adjustment mode. With this selection, there was a case where an image in which transfer voids had occurred in a location to which air had been blown at the time of feeding was output. It can be considered that this is because, in the comparative example, since it is not taken into consideration that the electrical resistance of a location to which air has been blown at the time of feeding has become large, an appropriate adjustment value has not been selected.

On the other hand, in the first exemplary embodiment, the abnormality of image quality did not occur due to the adjustment value selected by the adjustment mode and a good image was able to be output. In this way, in the first exemplary embodiment, it is possible to select an appropriate adjustment value even with respect to a recording material S in the surface of which an electrical resistance unevenness has occurred. Thus, in the first exemplary embodiment, it is possible to prevent or reduce the influence of blowing of air at the time of feeding and appropriately adjust the secondary transfer voltage.

Furthermore, while, in the first exemplary embodiment, a relationship between voltage and current at the time of outputting of a chart is approximated by a quadratic, the first exemplary embodiment is not limited to this. The relationship between voltage and current at the time of outputting of a chart can be approximated by a straight line or approximated by a polynomial of degree higher than 2 depending on, for example, the configuration of the image forming apparatus 1.

Moreover, in the first exemplary embodiment, a voltage-current characteristic is obtained with use of the applied voltages and detected currents at a plurality of adjustment patch positions at the time of outputting of a chart, and the current difference ΔId is obtained from a current detected with a predetermined voltage being applied at the position D and a current corresponding to the predetermined voltage in the voltage-current characteristic. However, the first exemplary embodiment is not limited to such an aspect, and the current difference ΔId can be obtained from a current detected with a predetermined voltage being applied at the position D and a current detected at an adjustment patch position to which the same predetermined voltage as that applied at the position D has been applied.

In this way, in the first exemplary embodiment, the image forming apparatus 1 includes an image bearing member (intermediate transfer belt) 44b which bears a toner image thereon, a transfer member 45b which forms a transfer portion N2 for transferring a toner image from the image bearing member 44b to a recording material S, an application unit 76 which applies, to the transfer portion N2, a transfer voltage for transferring a toner image from the image bearing member 44b to the recording material S, detection units 76a and 76b which detect a voltage and current obtained when a voltage has been applied to the transfer portion N2, acquisition units 91 and 92 which acquire information about the density of an image on the recording material S, a control unit 30 which is capable of performing control to execute an adjustment mode for setting a transfer voltage to be used at the time of image formation by forming a chart in which a plurality of density acquisition images each configured with a toner image has been transferred to the recording material S with a plurality of test voltages being applied to the transfer portion N2, outputting the formed chart, and acquiring information about the densities of the plurality of density acquisition images of the chart from the acquisition units 91 and 92, and a feeding unit 4 which feeds the recording material S toward the transfer portion N2 and which includes a blowing unit 49 which flows air to a leading edge portion of the recording material S in the conveyance direction of the recording material S at the time of the recording material S being sent from the feeding unit 4, wherein the control unit 30 sets a transfer voltage to be used at the time of image formation based on detection results obtained by the detection units 76a and 76b when a region (adjustment patch positions 1 to 10) to which at least one density acquisition image of the plurality of density acquisition images in the recording material S on which the chart is formed is passing through the transfer portion N2, detection results obtained by the detection units 76a and 76b when a predetermined region (position D) closer to the leading edge portion than a region to which a plurality of density acquisition images are transferred in the conveyance direction of the recording material S at the time of the recording material S being sent from the feeding unit within an image forming region of the recording material S on which the chart is formed is passing through the transfer portion N2, and information about the densities of a plurality of density acquisition images which are acquired from the acquisition units 91 and 92. In the first exemplary embodiment, the control unit 30 acquires a first current which is detected by the detection unit 76b with a predetermined voltage being applied to the transfer portion N2 when the predetermined region (position D) is passing through the transfer portion N2, a voltage-current characteristic that is based on detection results obtained by the detection units 76a and 76b when a region to which at least two density acquisition images of the plurality of density acquisition images are transferred is passing through the transfer portion N2, and a second current which is obtained based on the voltage-current characteristic and the predetermined voltage, and, in a case where the first current is smaller than the second current by a predetermined value or more, sets a transfer voltage to be used at the time of image formation based on a difference between the second current and the first current (current difference ΔId) and information about the densities of a plurality of density acquisition images which are acquired by the acquisition units 91 and 92. Moreover, the control unit 30 can be configured to acquire a first current which is detected by the detection unit 76b with a predetermined voltage being applied to the transfer portion N2 when the predetermined region is passing through the transfer portion N2 and a second current which is detected by the detection unit 76b with the predetermined voltage being applied to the transfer portion N2 when a region to which a predetermined density acquisition image of the plurality of density acquisition images is transferred is passing through the transfer portion N2, and, in a case where the first current is smaller than the second current by a predetermined value or more, set the transfer voltage to be used at the time of image formation based on a difference between the second current and the first current and information about the densities of a plurality of density acquisition images which are acquired by the acquisition units 91 and 92. Here, the control unit 30 sets a transfer voltage to be used at the time of image formation in such a manner that, in a case where the first current is smaller than the second current by the predetermined value or more, the absolute value of the transfer voltage becomes larger than in a case where the first current is not smaller than the second current by the predetermined value or more. Moreover, in the first exemplary embodiment, the predetermined region is a region to which an image configured with a toner image is not transferred in a recording material S in which the chart is formed. However, as described below, the predetermined region can be a region to which a predetermined image configured with a toner image for detecting the position of a density acquisition image is transferred in a recording material S in which the chart is formed (see a third exemplary embodiment).

As described above, according to the first exemplary embodiment, even in a case where an electrical resistance unevenness has occurred in the surface of a recording material S due to air being blown at the time of feeding, it is possible to adjust a secondary transfer voltage in consideration of a transfer current required for a location to which air has been blown. Therefore, according to the first exemplary embodiment, it becomes possible to perform appropriate adjustment of a secondary transfer voltage.

Next, a second exemplary embodiment of the present disclosure is described. The basic configuration and operation of an image forming apparatus in the second exemplary embodiment are the same as those of the image forming apparatus in the first exemplary embodiment. Accordingly, in the image forming apparatus in the second exemplary embodiment, elements having functions or configurations identical to or corresponding to those of the image forming apparatus in the first exemplary embodiment are assigned the respective same reference characters as those in the first exemplary embodiment, and are omitted from detailed description. Even in the second exemplary embodiment, as with the first exemplary embodiment, the case of performing “two-sided adjustment” is described.

The second exemplary embodiment differs from the first exemplary embodiment in a method of applying a voltage at the time of outputting of a chart in an adjustment mode.

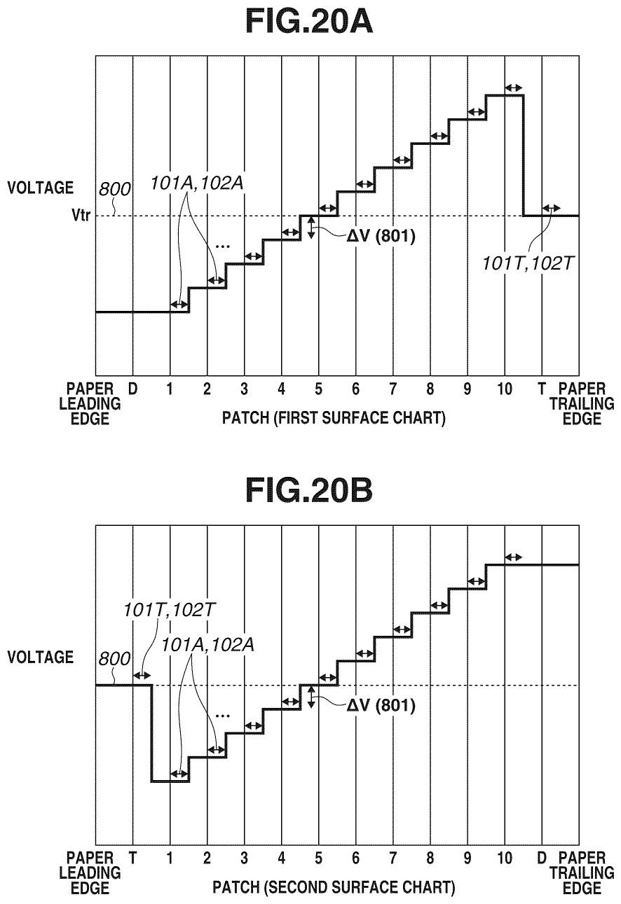

FIGS. 20A and 20B are graphs illustrating transition of an output of the secondary transfer power source 76 at the time of secondarily transferring a chart to a recording material S in the case of an L chart 100. FIG. 20A illustrates the transition in the first surface chart at the time of two-sided adjustment, and FIG. 20B illustrates the transition in the second surface chart at the time of two-sided adjustment. In the second exemplary embodiment, at the trigger patch position T, a voltage corresponding to the patch number n=5 (a voltage indicated by dashed line 800 in FIGS. 20A and 20B) is applied, and, at the position D, a voltage corresponding to a patch number adjacent to the position D (in the first surface chart, the patch number n=1, and, in the second surface chart, the patch number n=10) is applied.

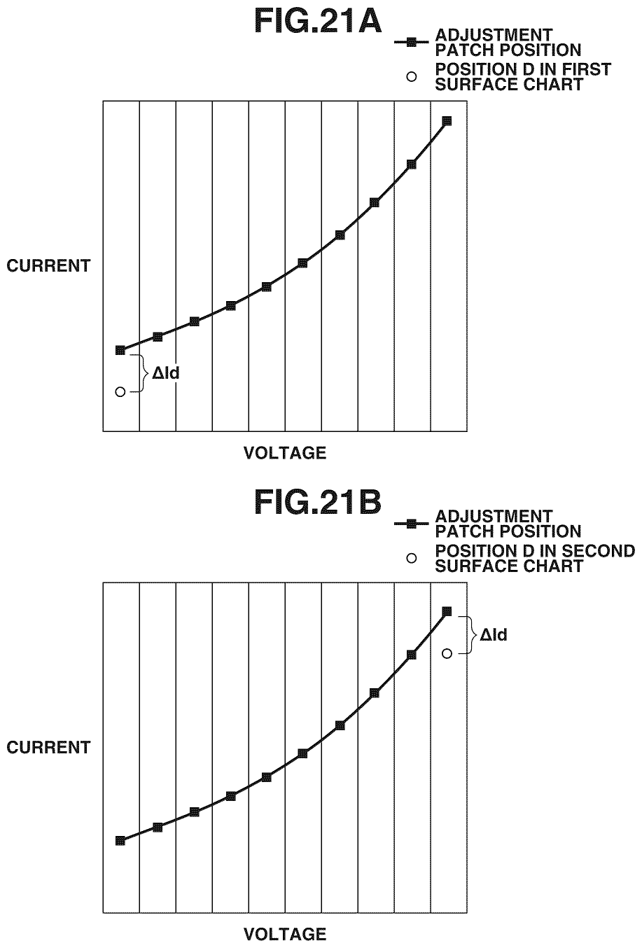

FIGS. 21A and 21B are graphs illustrating a relationship (voltage-current characteristic) between voltage and current which is acquired at the time of outputting of a chart in the second exemplary embodiment. FIG. 21A illustrates a relationship between voltage and current which is acquired in the first surface chart, and FIG. 21B illustrates a relationship between voltage and current which is acquired in the second surface chart. Even in the second exemplary embodiment, it is possible to obtain the current difference ΔId in step S8 illustrated in FIG. 8 in the way similar to that in the first exemplary embodiment. Thus, the control unit 30 (adjustment process unit 31d) obtains a relationship between the voltages applied and currents detected at the adjustment patch positions 1 to 10 by approximating the relationship by a quadratic function (I=a×V²+b×V+c). Then, the control unit 30 (adjustment process unit 31d) is able to calculate the current difference ΔId by the following equation where the current detected with the voltage Vtr being applied at the position D is denoted by Id:

ΔId=(a×Vtr²+b×Vtr+c)−Id.

In the case of two-sided adjustment, a relationship between the voltages applied and currents detected at the adjustment patch positions 1 to 10 and the current difference ΔId are acquired and calculated in each of the first surface chart and the second surface chart.

The other aspects of the adjustment mode, such as the method of correcting an adjustment value using the current difference ΔId in step S14 illustrated in FIG. 8, are similar to those in the first exemplary embodiment.

As described above, according to the second exemplary embodiment, it is possible to obtain an advantageous effect similar to that in the first exemplary embodiment and attain simplification of control of the secondary transfer power source 76.

Next, a third exemplary embodiment of the present disclosure is described. The basic configuration and operation of an image forming apparatus in the third exemplary embodiment are the same as those of the image forming apparatus in the first exemplary embodiment. Accordingly, in the image forming apparatus in the third exemplary embodiment, elements having functions or configurations identical to or corresponding to those of the image forming apparatus in the first exemplary embodiment are assigned the respective same reference characters as those in the first exemplary embodiment, and are omitted from detailed description.

In the third exemplary embodiment, the case of performing one-sided adjustment is described. The case of performing one-sided adjustment differs from the case of performing two-sided adjustment, described in the first exemplary embodiment, in a relationship between the location to which air is blown and the trigger patch position.

In the case of performing adjustment of only a secondary transfer voltage at the time of one-sided printing (“one-sided adjustment”), in the adjustment mode, the following charts are output. In the case of outputting an L chart 100, with an image forming operation for one-sided printing, a chart 100(2) illustrated in FIG. 6 is formed on the first surface of one recording material S and is then output. Moreover, in the case of outputting an S chart 103, with an image forming operation for one-sided printing, a chart 103(2-1) and a chart 103(2-2) illustrated in FIG. 7 are formed on the first surface of the first recording material S and the first surface of the second recording material S, respectively, and are then output. Thus, charts which are directed to the second surface in the case of performing adjustment of a secondary transfer voltage for the first surface and the second surface at the time of two-sided printing are output without passing through the reversing conveyance path 7 in an image forming operation for one-side printing. Moreover, reading of the chart is performed with use of the second line sensor 92 of the sensing unit 3. With this operation, since the orientation of a read image is not changed from that taken at the time of two-sided adjustment and the recording material S does not pass through the reversing conveyance path 7, it is possible to perform one-sided adjustment while minimizing downtime (a time in which an image is not able to be output due to, for example, execution of adjustment).

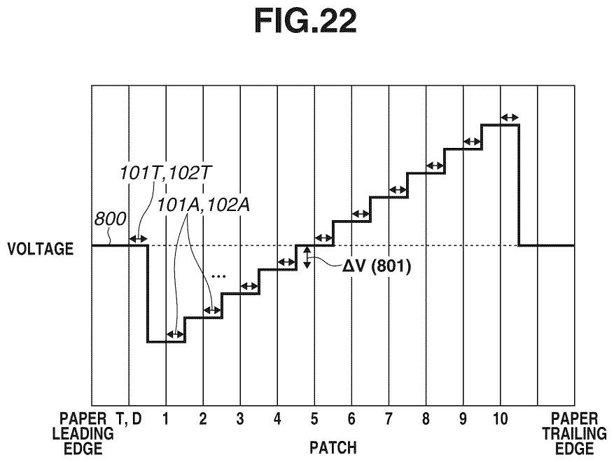

FIG. 22 is a graph illustrating transition of an output of the secondary transfer power source 76 in secondarily transferring the L chart 100 to a recording material S in one-sided adjustment. In the third exemplary embodiment, the trigger patch position T and a location to which air has been blown at the time of feeding are close to each other (the trigger patch position T is included in the location to which air has been blown at the time of feeding). Therefore, in the third exemplary embodiment, the current difference ΔId is obtained with use of a relationship between the voltage applied and current detected at the trigger patch position T. Thus, in the third exemplary embodiment, the trigger patch position T also serves as a region (position D) for acquiring information about the electrical resistance of a recording material S in the vicinity of the leading edge of the recording material S in the conveyance direction thereof at the time of the recording material S being sent from the feeding unit 4.

Furthermore, the trigger patches 101T and 102T are those used to perform position detection of patches at the time of reading of a chart in the sensing unit 3. Therefore, even in a case where the electrical resistance of a recording material S at such a location increases due to air being blown at the time of feeding so that the transferability has slightly lowered, there is almost no problem.

The other aspects of the adjustment mode, such as the method of calculating the current difference ΔId in step S8 illustrated in FIG. 8 and the method of correcting an adjustment value using the current difference ΔId in step S14 illustrated in FIG. 8, are similar to those in the first exemplary embodiment.

As described above, according to the third exemplary embodiment, it is possible to obtain an advantageous effect similar to that in the first exemplary embodiment while preventing or reducing downtime at the time of one-sided adjustment.

Next, a fourth exemplary embodiment of the present disclosure is described. The basic configuration and operation of an image forming apparatus in the fourth exemplary embodiment are the same as those of the image forming apparatus in the first exemplary embodiment. Accordingly, in the image forming apparatus in the fourth exemplary embodiment, elements having functions or configurations identical to or corresponding to those of the image forming apparatus in the first exemplary embodiment are assigned the respective same reference characters as those in the first exemplary embodiment, and are omitted from detailed description.

It may be favorable that the adjustment patch position is set to a location to which air is blown in the vicinity of the leading edge of a recording material S in the conveyance direction at the time of the recording material S being sent from the feeding unit 4, i.e., a location which is sufficiently small in a change of the electrical resistance due to air being blown at the time of feeding. However, it may also be assumed that, depending on designs of charts, the adjustment patch position is set to a location to which air is blown at the time of feeding. For example, in such a case, the adjustment patch position can also serve as a region (position D) for acquiring information about the electrical resistance of a recording material S in the vicinity of the leading edge of the recording material S in the conveyance direction thereof at the time of the recording material S being sent from the feeding unit 4.

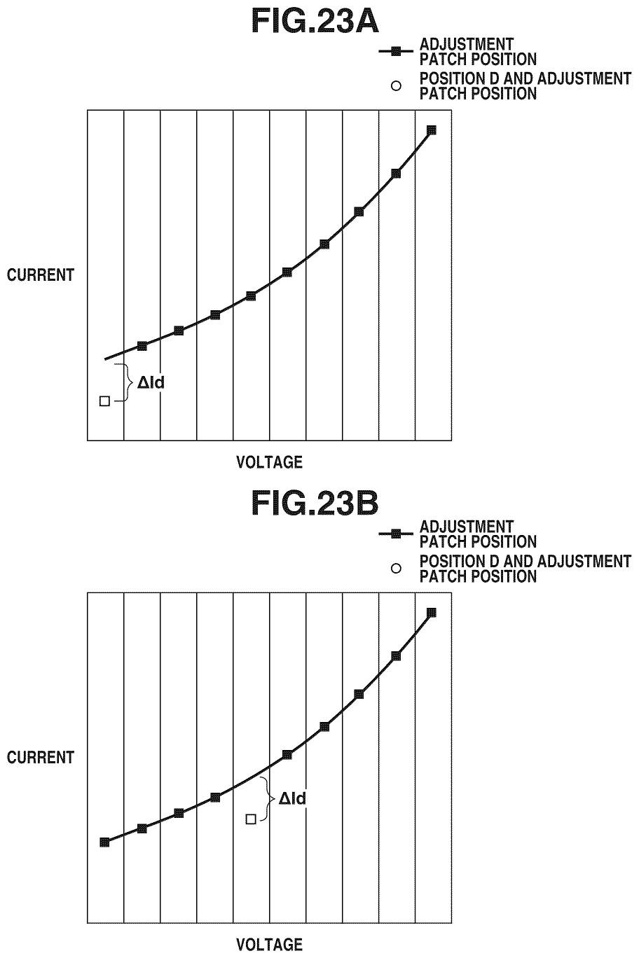

FIG. 23A is a graph illustrating an example of a relationship (voltage-current characteristic) between voltage and current which is acquired at the time of outputting of a chart in a case where the adjustment patch position also serves as the position D. FIG. 23A illustrates an example of the case where an L chart 100 has been output (the first surface chart in two-sided adjustment), in a case where the adjustment patch position 1 is included in a location to which air has been blown at the time of feeding, as an example, in a configuration including the air blowing unit 49 similar to that described in the first exemplary embodiment. It is known in advance that the adjustment patch position 1 is a position at which the electrical resistance of a recording material S may increase due to air being blown at the time of feeding. In this case, in step S8 illustrated in FIG. 8, the current difference ΔId can be obtained in the following way. Thus, the control unit 30 (adjustment process unit 31d) obtains a relationship between the voltages applied and currents detected at the adjustment patch positions 2 to 10, with the exception of the adjustment patch position 1 (also serving as the position D), by approximating the relationship by a quadratic function (I=a×V²+b×V+c). Then, the control unit 30 (adjustment process unit 31d) is able to calculate the current difference ΔId by the following equation where the current detected with the voltage Vtr being applied at the adjustment patch position 1 (also serving as the position D) is denoted by Id:

ΔId=(a×Vtr²+b×Vtr+c)−Id.

The other aspects of the adjustment mode, such as the method of correcting an adjustment value using the current difference ΔId, are similar to those in the first exemplary embodiment. Even in correction of an adjustment value, the above-mentioned relationship between the voltages applied and currents detected at the adjustment patch positions 2 to 10 can be used. Moreover, a configuration in which, in a case where the current difference ΔId is greater than or equal to a predetermined threshold value, density information about the adjustment patch position 1 is not used for selection of an adjustment value can be employed. Furthermore, even in the case of one-sided adjustment, control similar to that described above can be performed. Moreover, in a case where, in the second surface chart in two-sided adjustment, for example, the adjustment patch position 10 is included in a location to which air has been blown at the time of feeding, similar control can be performed with use of a detection result of the current at the adjustment patch position 10 instead of the above-mentioned adjustment patch position 1.

FIG. 23B is a graph illustrating another example of a relationship (voltage-current characteristic) between voltage and current which is acquired at the time of outputting of a chart in a case where the adjustment patch position also serves as the position D.

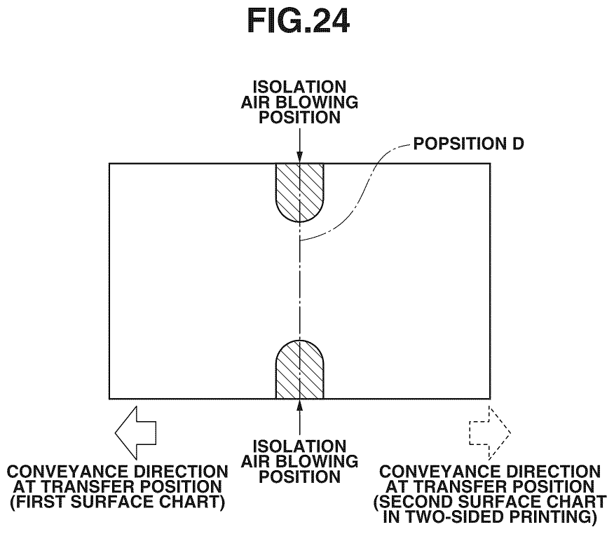

FIG. 23B illustrates an example of the case where an L chart 100 has been output in a configuration including an air blowing unit 49 which blows air from both end sides to the center side in the width direction at the vicinity of the center of a recording material S in the conveyance direction at the time of the recording material S being sent from the feeding unit 4. FIG. 24 is a schematic diagram illustrating the positions to which air is blown of a recording material S in the feeding unit 4 in such a case. For example, the adjustment patch position 5 is assumed to be included in a location to which air is blown at the time of feeding. It is known in advance that the adjustment patch position 5 is a position at which the electrical resistance of a recording material S may increase due to air being blown at the time of feeding. In this case, in step S8 illustrated in FIG. 8, the current difference ΔId can be obtained in the following way. Thus, the control unit 30 (adjustment process unit 31d) obtains a relationship between the voltages applied and currents detected at the adjustment patch positions 1 to 4 and 6 to 10, with the exception of the adjustment patch position 5 (also serving as the position D), by approximating the relationship by a quadratic function (I=a×V²+b×V+c). Then, the control unit 30 (adjustment process unit 31d) is able to calculate the current difference ΔId by the following equation where the current detected with the voltage Vtr being applied at the adjustment patch position 5 (also serving as the position D) is denoted by Id:

ΔId=(a×Vtr²+b×Vtr+c)−Id.

The other aspects of the adjustment mode, such as the method of correcting an adjustment value using the current difference ΔId, are similar to those in the first exemplary embodiment. Even in correction of an adjustment value, the above-mentioned relationship between the voltages applied and currents detected at the adjustment patch positions 1 to 4 and 6 to 10 can be used. Moreover, a configuration in which, in a case where the current difference ΔId is greater than or equal to a predetermined threshold value, density information about the adjustment patch position 5 is not used for selection of an adjustment value can be employed. Furthermore, even in the case of one-sided adjustment, control similar to that described above can be performed. Moreover, even in the second surface chart in two-sided adjustment, similar control can be performed with use of a detection result of the current at the adjustment patch position also serving as the position D.

Furthermore, in the case of a configuration described above with reference to FIGS. 23A and 23B, first, a relationship between the voltages and currents can be obtained with use of detection results at all of the adjustment patch positions. Then, only in a case where an index (correlation function) for finding a relationship between pieces of data satisfies a predetermined condition (for example, falls below a predetermined value), a relationship between the voltages and currents can be obtained with use of detection results at the adjustment patch positions excluding the adjustment patch position also serving as the position D.

Moreover, the number of adjustment patch positions each also serving as the position D is not limited to one. In a case where there is a plurality of adjustment patch positions in which the electrical resistance of a recording material S may increase due to air being blown at the time of feeding, the voltages and currents can be obtained with use of detection results at adjustment patch positions excluding the plurality of adjustment patch positions. Then, the current difference ΔId can be obtained by comparing a relationship between the obtained voltages and currents with a detection result of at least one of the plurality of adjustment patch positions each also serving as the position D.

In this way, the image forming apparatus 1 includes the feeding unit 4, which feeds a recording material S toward the secondary transfer portion N2 and includes the air blowing unit 49, which, when the recording material S is sent from the feeding unit 4, blows air from the blowing port (isolation nozzle) 49c (FIG. 19A) to the recording material S. Then, in the fourth exemplary embodiment, the control unit 30 obtains a first current which is detected by the current detection sensor 76b with a predetermined voltage being applied to the secondary transfer portion N2 when a first region to which a density acquisition image is transferred of a recording material S on which a chart is formed is passing through the secondary transfer portion N2, a voltage-current characteristic that is based on detection results obtained by the voltage detection sensor 76a and the current detection sensor 76b when at least one second region to which a density acquisition image is transferred farther from the blowing port 49c than the first region when the recording material S is sent (in more detail, is placed on the feeding unit 4 in such a way as to be sent) from the feeding unit 4 is passing through the secondary transfer portion N2, and a second current which is obtained based on the voltage-current characteristic and the predetermined voltage, and, in a case where the first current is smaller than the second current by a predetermined value or more, sets a transfer voltage at the time of image formation based on a difference between the first current and the second current (current difference ΔId) and information about the densities of a plurality of density acquisition images which are acquired by the detection units (line sensors) 91 and 92. Here, the control unit 30 sets the transfer voltage in such a manner that, in a case where the first current is smaller than the second current by the predetermined value or more, the absolute value of the transfer voltage becomes larger than in a case where the first current is not smaller than the second current by the predetermined value or more. Furthermore, the configuration described above in the first exemplary embodiment is equivalent to a case where the above-mentioned first region is a region to which an image configured with a toner image is not transferred in the recording material S on which a chart is formed. Moreover, the configuration described above in the third exemplary embodiment is equivalent to a case where the above-mentioned first region is a region to which a predetermined image configured with a toner image for detecting the position of each density acquisition image is transferred in the recording material S on which a chart is formed.

As described above, according to the fourth exemplary embodiment, it is possible to obtain an advantageous effect similar to that in the first exemplary embodiment by correcting an adjustment value for a secondary transfer voltage with use of a result of detection of the current at the adjustment patch position included in a location to which air has been blown at the time of feeding.

While specific exemplary embodiments have been described above, some embodiments are not limited to such exemplary embodiments.

While, in the above-described exemplary embodiments, the transfer voltage is adjusted with use of an adjustment value corresponding to a predetermined adjustment amount, for example, an adjustment amount can be directly set via, for example, an adjustment screen.

Moreover, an operation which is performed via an operation unit of the image forming apparatus in the above-described exemplary embodiments can be performed via an external apparatus. Thus, the case where the adjustment mode is executed with an operation being performed by the operator via the operation unit 70 of the image forming apparatus 1 has been described, the adjustment mode can be executed with an operation being performed by the operator via the external apparatus 200, such as a personal computer. In this case, the setting similar to that in the above-described exemplary embodiments can be performed via a screen which is displayed on a display unit of the external apparatus 200 by a driver program for the image forming apparatus 1 installed on the external apparatus 200.

Moreover, while, in the above-described exemplary embodiments, a configuration in which the secondary transfer voltage is subjected to constant voltage control has been described, the secondary transfer voltage can be subjected to constant current control. In the case of a configuration in which the secondary transfer voltage is subjected to constant current control, the adjustment mode is used to adjust a target current or an initial voltage at the time of application of the secondary transfer voltage, thus being able to adjust the secondary transfer voltage.

Moreover, the detection result of current or the detection result of voltage can be, for example, an average value of a plurality of sampling values acquired at a predetermined sampling interval on one detection timing. Moreover, in the case of performing constant voltage control on the transfer voltage, a voltage value can be detected (recognized) from an output instruction value for a power source, and, in the case of performing constant current control on the transfer voltage, a voltage value can be detected (recognized) from an output instruction value for a power source.

Moreover, while, in the above-described exemplary embodiments, the image forming apparatus includes a printer unit and a sensing unit which are independently unitized, some embodiments are not limited to such an aspect. Such a configuration being employed enables, for example, making the respective units separable from each other and preparing a function provided by the sensing unit as an advanced function of the image forming apparatus. However, the configuration of the printer unit and the configuration of the sensing unit in the above-described exemplary embodiments can be integrated by, for example, being arranged within one casing.

Moreover, in the above-described exemplary embodiments, in the adjustment mode, in-line image sensors (first and second line sensors) are used to read a chart. Thus, in the above-described exemplary embodiments, an acquisition unit which acquires information about the density of an image on a recording material is configured to, when a recording material with a chart formed thereon is discharged from the image forming apparatus, acquire information about the density of a density acquisition image on the chart. This enables reducing a burden on the operator. However, some embodiments are not limited to such an aspect, and, for example, a configuration in which the operator sets a chart output in the adjustment mode on the image reading unit 80 (FIG. 1) and the image reading unit 80 reads the chart can be employed. In this way, the acquisition unit which acquires information about the density of an image on a recording material can be configured to, when a recording material with a chart formed thereon discharged from the image forming apparatus has been set, acquire information about the density of a density acquisition image on the chart.

Moreover, as mentioned above, the case of using heavy paper with a grammage larger than that of plain paper as a recording material easily makes the difference of electrical resistance conspicuous between a location to which air has been blown at the feeding unit and the other locations and exhibits the tendency that the difference of transferability caused by an electrical resistance unevenness is likely to occur. Therefore, for example, a configuration in which, only in a case where a heavy paper with a grammage of a predetermined value or more is used as a recording material, control (correction of an adjustment value) using a detection result of current at the position D such as that described in the above-described exemplary embodiments is performed can be employed.

Moreover, the image forming apparatus is not limited to a tandem-type image forming apparatus, but can be an another-type image forming apparatus. Moreover, the image forming apparatus is not limited to an image forming apparatus capable of forming a full-color image, but can also be an image forming apparatus capable of forming only a monochromatic (black-and-white or mono-color) image. For example, with regard to an image forming apparatus having a configuration in which a toner image is formed on a photosensitive drum serving as an image bearing member and the formed toner image is directly transferred by a transfer unit to a recording material, the present disclosure can also be applied to such a transfer unit.

Moreover, the image forming apparatus can be any one of image forming apparatuses for various use applications, such as printers, various types of printing machines, copying machines, facsimile apparatuses, and multifunction peripherals.

According to aspects of the present disclosure, in a configuration which blows air to a recording material at the time of feeding the recording material, it becomes possible to appropriately set a setting voltage for a secondary transfer voltage even with respect to a recording material in the surface of which an electrical resistance unevenness has occurred.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-110366, which was filed on Jul. 4, 2023 and which is hereby incorporated by reference herein in its entirety.

What is claimed is:

1. An image forming apparatus comprising:
an image bearing member configured to bear a toner image thereon;
a transfer member configured to transfer a toner image from the image bearing member to a recording material at a transfer portion;
an application unit configured to apply a voltage to the transfer member;
a sensor configured to detect a current value of a current flowing to the transfer member when a voltage has been applied from the application unit to the transfer member or a voltage value of a voltage which is applied from the application unit to the transfer member;
an image reading unit configured to detect an image on a recording material;
a container configured to contain recording materials therein;
a blowing unit including a blowing port configured to blow air to recording materials contained in the container;
a feeding unit configured to feed a recording material contained in the container toward the transfer portion; and
a control unit configured to execute a setting mode for transferring a plurality of test images to a recording material with different test voltages applied to the transfer member during non-image formation and setting a transfer voltage to be applied to the transfer member during image formation based on a detection result obtained by the image reading unit detecting the plurality of test images transferred to the recording material,
wherein in the adjustment mode the control unit is configured to set the transfer voltage to be applied during image formation based on a first detection result obtained by the sensor when a voltage is applied to the transfer member while a first region of a recording material on which the plurality of test images is to be formed is passing through the transfer portion, and a voltage-current characteristic, which is acquired based on a second detection result, which is obtained by the sensor when a voltage is applied to the transfer member while a second region of the recording material on which the plurality of test images is to be formed and which is different from the first region in a conveyance direction of the recording material is passing through the transfer portion, and
wherein, when the recording material on which the plurality of test images is to be formed is contained in the container portion, the second region is a region more away from the blowing port than the first region.

2. The image forming apparatus according to claim 1, wherein, when the recording material on which the plurality of test images is to be formed is contained in the container portion, in a case where a region within 50 millimeters (mm) from an edge of a recording material closest to the blowing port in an air blowing direction of the blowing unit is set as a predetermined region, the first region is a region which overlaps the predetermined region, and the second region is a region which does not overlap the predetermined region.

3. The image forming apparatus according to claim 1, wherein the first region is a region on which the plurality of test images is to be formed, and the second region is a region on which the plurality of test images is not to be formed.

4. The image forming apparatus according to claim 1, wherein the second region is a region on which a position detection image for detecting a position of the plurality of test images is to be formed.

5. The image forming apparatus according to claim 1, wherein the control unit acquires the voltage-current characteristic based on the first detection result and a third detection result obtained by the image reading unit when a third region of the recording material on which the plurality of test images is to be formed and which is different from the first region is passing through the transfer member, and sets the transfer voltage based on the voltage-current characteristic and the second detection result.

6. The image forming apparatus according to claim 1, wherein the control unit controls the application unit in such a manner that a predetermined voltage is applied to the transfer member when the first region is passing through the transfer member, the first detection result is a first current which flows when the first region is passing through the transfer member, the control unit controls the application unit in such a manner that the predetermined voltage is applied to the transfer member when the second region is passing through the transfer member, and the second detection result is a second current which flows when the second region is passing through the transfer member.

7. The image forming apparatus according to claim 6, wherein the control unit controls the application unit in such a manner that, in a case where a difference between the first current and the second current is larger than a predetermined value, an absolute value of the transfer voltage which is set during image formation is a first transfer voltage and, in a case where a difference between the first current and the second current is smaller than the predetermined value, an absolute value of the transfer voltage which is set during image formation is a second transfer voltage.

8. An image forming apparatus comprising:
an image bearing member configured to bear a toner image thereon;
a transfer member configured to transfer a toner image from the image bearing member to a recording material at a transfer portion;
an application unit configured to apply a voltage to the transfer member;
a sensor configured to detect a current value of a current flowing to the transfer member when a voltage has been applied from the application unit to the transfer member or a voltage value of a voltage which is applied from the application unit to the transfer member;
an image reading unit configured to detect an image on a recording material;
a container configured to contain recording materials therein;
a blowing unit including a blowing port configured to blow air to recording materials contained in the container;
a feeding unit configured to feed a recording material contained in the container toward the transfer portion; and
a control unit configured to execute a setting mode for transferring a plurality of test images to a recording material with different test voltages applied to the transfer member during non-image formation and setting a transfer voltage to be applied to the transfer member during image formation based on a detection result obtained by the image reading unit detecting the plurality of test images transferred to the recording material,
wherein in the adjustment mode the control unit is configured to set the transfer voltage to be applied during image formation based on a first detection result obtained by the sensor when a predetermined voltage is applied to the transfer member while a first region of a recording material on which the plurality of test images is to be formed is passing through the transfer portion and a second detection result obtained by the sensor when the predetermined voltage is applied to the transfer member while a second region of the recording material on which the plurality of test images is to be formed and which is different from the first region in a conveyance direction of the recording material is passing through the transfer portion, and
wherein, when the recording material on which the plurality of test images is to be formed is contained in the container portion, the second region is a region more away from the blowing port than the first region.

9. The image forming apparatus according to claim 8, wherein, when the recording material on which the plurality of test images is to be formed is contained in the container portion, in a case where a region within 50 millimeters (mm) from an edge of a recording material closest to the blowing port in an air blowing direction of the blowing unit is set as a predetermined region, the first region is a region which overlaps the predetermined region, and the second region is a region which does not overlap the predetermined region.
